(19) United States
(12) Patent Application Publication
(10) Pub. No.: US 2020/0096167 A1
(43) Pub. Date: Mar. 26, 2020

(54) LIGHT-DIFFUSION MEMBER AND DAYLIGHTING DEVICE

(71) Applicant: SHARP KABUSHIKI KAISHA, Sakai City, Osaka (JP)

(72) Inventors: YASUSHI ASAOKA, Sakai City, Osaka (JP); TORU KANNO, Sakai City, Osaka (JP); HIDEOMI YUI, Sakai City, Osaka (JP)

(21) Appl. No.: 16/470,344

(22) PCT Filed: Dec. 21, 2017
(86) PCT No.: PCT/JP2017/045953

§ 371 Date: Jun. 17, 2019

(30) Foreign Application Priority Data
Dec. 21, 2016 (JP) 2016-248409

(51) Int. Cl. F21S 11/00; G02B 3/06; G02B 3/00; G02B 5/02

(52) U.S. Cl. CPC F21S 11/002; G02B 5/0278; G02B 3/0056; G02B 3/06

(57) ABSTRACT

A light-diffusion member includes a plurality of cylindrical lenses arrayed in a prescribed direction, wherein the cylindrical lenses are arrayed in a first direction and extended in a second direction that is perpendicular to the first direction, the cylindrical lenses each have a curved lens surface, and the lens surface has a height that continuously changes with a prescribed period in a cross-section of the cylindrical lens taken along a second imaginary plane that is perpendicular to a first imaginary plane containing both the first direction and the second direction and that is parallel to the second direction.

### TECHNICAL FIELD

The present invention, in an aspect thereof, relates to light-diffusion members and daylighting devices.

The present application claims the benefit of priority to Japanese Patent Application, Tokugan, No. 2016-248409, filed in Japan on Dec. 21, 2016, the entire contents of which are incorporated herein by reference.

### BACKGROUND ART

Patent Literature 1 discloses a daylighting device for letting sunlight enter indoors, for example, through a window of a building. The daylighting device described in Patent Literature 1 includes: a daylighting member composed of a base member including a plurality of daylighting sections; and a light-diffusion member for diffusing, in particular directions, the light exiting the daylighting member.

Patent Literature 1 gives an example where a lenticular lens is used as the light-diffusion member.

The lenticular lens includes an array of cylindrical lenses arranged side by side in a direction perpendicular to the direction in which the cylindrical lenses are extended. The direction in which the cylindrical lenses are extended is perpendicular to the direction in which the daylighting sections are extended.

### CITATION LIST

### Patent Literature

Patent Literature 1: PCT International Application Publication No. WO2015/156225

### SUMMARY OF INVENTION

### Technical Problem

In the daylighting device of Patent Literature 1, sunlight passes through the daylighting sections constructed of prismatic structural bodies. Upon leaving the daylighting device, sunlight is diffused, for example, horizontally into the room by the light-diffusion member composed of an array of cylindrical lenses. This diffused light can brightly illuminate a horizontally broad area. Meanwhile, sunlight is dispersed vertically during passage through the daylighting sections, causing the light-diffusion member to emit the resultant dispersed light. In addition, it is extremely rare that the dispersed light is vertically mingled by the cylindrical lenses, because the cylindrical lenses do not vertically refract incoming light. As a result, the light reaching the inside of the room is colored, failing to deliver white light suitable for general lighting.

The present invention, in an aspect thereof, has been made to address this problem and has an object to provide a daylighting device capable of letting in light that is close to white light. The aspect of the present invention has another object to provide a light-diffusion member suitable for use in the daylighting device.

### Solution to Problem

In order to achieve these objects, the present invention, in an aspect thereof, is directed to a light-diffusion member including a plurality of cylindrical lenses arrayed in a prescribed direction, wherein the cylindrical lenses are arrayed in a first direction and extended in a second direction that is perpendicular to the first direction, the cylindrical lenses each have a curved lens surface, and the lens surface has a height that continuously changes with a prescribed period in a cross-section of the cylindrical lens taken along a second imaginary plane that is perpendicular to a first imaginary plane containing both the first direction and the second direction and that is parallel to the second direction.

The light-diffusion member, in another aspect of the present invention, may further include a first base member transparent to visible light, wherein the cylindrical lenses are provided on a first face of the first base member.

The light-diffusion member, in another aspect of the present invention, may be configured such that the height of the lens surface is substantially constant across the cylindrical lens and that the cylindrical lens has a ridge line that is at least partly curved or bent when viewed normal to the first imaginary plane.

The light-diffusion member, in another aspect of the present invention, may be configured such that the cylindrical lenses each have in a curved or bending section thereof an inclined section tilted with respect to the second direction, the second direction forming an angle of less than 45° with a direction in which the inclined section is extended.

The light-diffusion member, in another aspect of the present invention, may be configured such that the cylindrical lenses each have a ridge line linearly extended generally parallel to the second direction when viewed normal to the first imaginary plane and that the height of the lens surface continuously changes with a prescribed period along the ridge line when viewed normal to the first imaginary plane.

The light-diffusion member, in another aspect of the present invention, may be configured such that the cylindrical lenses have a variable array period.

The light-diffusion member, in another aspect of the present invention, may be configured such that the cylindrical lenses each include a light-scattering member therein.

The light-diffusion member, in another aspect of the present invention, may be configured such that the cylindrical lenses each include a light-scattering structure on the lens surface thereof.

The present invention, in an aspect thereof, is directed to a daylighting device including: a daylighting member including: a second base member transparent to visible light; and a plurality of daylighting sections transparent to visible light provided on a first face of the second base member; and the light-diffusion member of one of the aspects of the present invention provided on a light-emitting side of the daylighting member.

The present invention, in an aspect thereof, is directed to a daylighting device including: the light-diffusion member of one of the aspects of the present invention; and a plurality of daylighting sections transparent to visible light provided on a second face of a first base member.

The daylighting device, in another aspect of the present invention, may be configured such that the daylighting sections are arrayed in a direction that crosses the direction in which the cylindrical lenses are arrayed.

The daylighting device, in another aspect of the present invention, may be configured such that the height of the lens surface changes with a prescribed period and that the period of the changing height of the lens surface differs from an array period of the daylighting sections.

The daylighting device, in another aspect of the present invention, may be configured such that the cylindrical lenses each include a light-scattering member therein.

The daylighting device, in another aspect of the present invention, may be configured such that the cylindrical lenses each include a light-scattering structure on a surface thereof.

### Advantageous Effects of Invention

The present invention, in an aspect thereof, provides a daylighting device capable of letting in light that is close to white light and also provides a light-diffusion member suitable for use in the daylighting device.

### BRIEF DESCRIPTION OF DRAWINGS

FIG. 1 is a perspective view of a daylighting device in accordance with a first embodiment.

FIG. 2 is a front view of the daylighting device.

FIG. 3 is a rear view of the daylighting device.

FIG. 4 is a cross-sectional view of the daylighting device, taken along line IV-IV shown in FIGS. 2 and 3.

FIG. 5 is a cross-sectional view of the daylighting device, taken along line V-V shown in FIGS. 2 and 3.

FIG. 6 is a front view of a daylighting device in accordance with a first variation example.

FIG. 7 is a front view of a daylighting device in accordance with a second variation example.

FIG. 8 is a front view of a daylighting device in accordance with a third variation example.

FIG. 9 is a front view of a daylighting device in accordance with a comparative example.

FIG. 10 is a rear view of the daylighting device in accordance with the comparative example.

FIG. 11 is a cross-sectional view of the daylighting device in accordance with the comparative example, taken along line XI-XI shown in FIGS. 9 and 10.

FIG. 12 is a front view of a conventional daylighting device.

FIG. 13 is a rear view of the conventional daylighting device.

FIG. 14 is a cross-sectional view of the conventional daylighting device, taken along line XIV-XIV shown in FIGS. 12 and 13.

FIG. 15A is a cross-sectional view of a daylighting device in accordance with a fourth variation example.

FIG. 15B is a cross-sectional view of another daylighting device in accordance with the fourth variation example.

FIG. 15C is a cross-sectional view of a further daylighting device in accordance with the fourth variation example.

FIG. 16A is a cross-sectional view of a daylighting device in accordance with a fifth variation example.

FIG. 16B is a cross-sectional view of a daylighting device in accordance with a sixth variation example.

FIG. 16C is a cross-sectional view of a daylighting device in accordance with a seventh variation example.

FIG. 16D is a cross-sectional view of a daylighting device in accordance with an eighth variation example.

FIG. 16E is a cross-sectional view of a daylighting device in accordance with a ninth variation example.

FIG. 16F is a cross-sectional view of a daylighting device in accordance with a tenth variation example.

FIG. 17 is a cross-sectional view of a daylighting device in accordance with an eleventh variation example.

FIG. 18 is a schematic diagram of an example manufacturing machine for a daylighting device.

FIG. 19 is a perspective view of an example metal die.

FIG. 20 is a schematic diagram of another example manufacturing machine for a daylighting device.

FIG. 21 is a schematic diagram of a further example manufacturing machine for a daylighting device.

FIG. 22 is a front view of an example pattern of bending sections of cylindrical lenses.

FIG. 23 is a microscope image of a prototype light-diffusion film.

FIG. 24A is a diagram representing a luminance distribution of light exiting a light-diffusion film in accordance with an example of the invention.

FIG. 24B is a diagram representing a luminance distribution of light exiting a conventional light-diffusion film.

FIG. 25 is a graph representing a relationship between a polar angle and a transmittance for light exiting a light-diffusion film composed of a transparent resin, obtained for different values of azimuth.

FIG. 26 is a graph representing a relationship between a polar angle and a transmittance for light exiting a light-diffusion film composed of a poorly scattering resin, obtained for different values of azimuth.

FIG. 27 is a graph representing a relationship between a polar angle and a transmittance for light exiting a light-diffusion film composed of a moderately scattering resin, obtained for different values of azimuth.

FIG. 28 is a diagram representing a chromaticity distribution of light exiting a daylighting device that includes a light-diffusion film composed of a transparent resin.

FIG. 29 is a diagram representing a chromaticity distribution of light exiting a daylighting device that includes a light-diffusion film composed of a poorly scattering resin.

FIG. 30 is a diagram representing a chromaticity distribution of light exiting a daylighting device that includes a light-diffusion film composed of a moderately scattering resin.

FIG. 31 is a diagram representing a chromaticity distribution of light exiting a conventional daylighting device.

FIG. 32 is a front view showing an example shape of an optimal cylindrical lens.

FIG. 33 is a front view showing a shape of a cylindrical lens in accordance with a comparative example.

FIG. 34 is a graph representing a relationship between the lens pitch and bending period of a cylindrical lens, obtained for different bending angles thereof.

FIG. 35 is a perspective view of a daylighting device in accordance with a second embodiment.

FIG. 36 is a front view of the daylighting device in accordance with the second embodiment.

FIG. 37 is a cross-sectional view of the daylighting device, taken along line XXXVII-XXXVII shown in FIG. 36.

FIG. 38 is a cross-sectional view of the daylighting device, taken along line XXXVIII-XXXVIII shown in FIG. 36.

FIG. 39 is a cross-sectional view of the daylighting device, taken along line XXXIX-XXXIX shown in FIG. 36.

FIG. 40 is a plan view of a daylighting device in accordance with a first variation example.

FIG. 41 is a plan view of a daylighting device in accordance with a second variation example.

FIG. 42 is a plan view of a daylighting device in accordance with a third variation example.

FIG. 43 is a cross-sectional view of a daylighting device in accordance with a third embodiment.

FIG. 44 is a cross-sectional view of a daylighting device in accordance with a first variation example.

FIG. 45 is a cross-sectional view of a daylighting device in accordance with a second variation example.

FIG. 46 is a cross-sectional view of a daylighting device in accordance with a third variation example.

FIG. 47 is a perspective view of a daylighting device in accordance with a fourth embodiment.

FIG. 48 is a cross-sectional view of the daylighting device.

FIG. 49 is a perspective view of a daylighting device in accordance with a fifth embodiment.

FIG. 50 is a cross-sectional view of the daylighting device.

FIG. 51 is a cross-sectional view of a room in which a daylighting device is installed.

FIG. 52 is a plan view of a ceiling of the room.

FIG. 53 is a graph representing a relationship between the illuminance produced by daylighting light (natural light) guided indoors by a daylighting device and the illuminance produced by room lighting devices.

### DESCRIPTION OF EMBODIMENTS

### First Embodiment

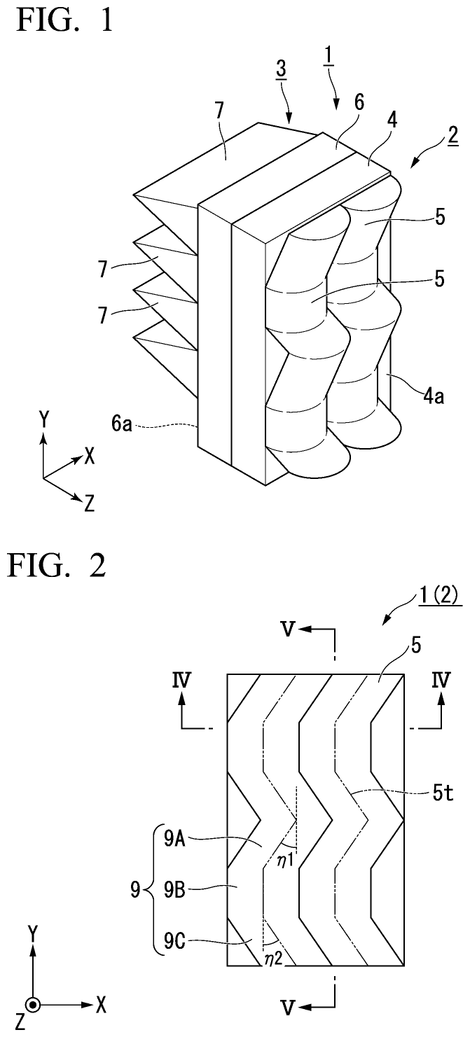

The following will describe a first embodiment of the present invention in reference to FIGS. 1 to 34.

The first embodiment gives, as an example of a daylighting device in accordance with the present invention, an example of a daylighting sheet in which a daylighting film and a light-diffusion film are attached together.

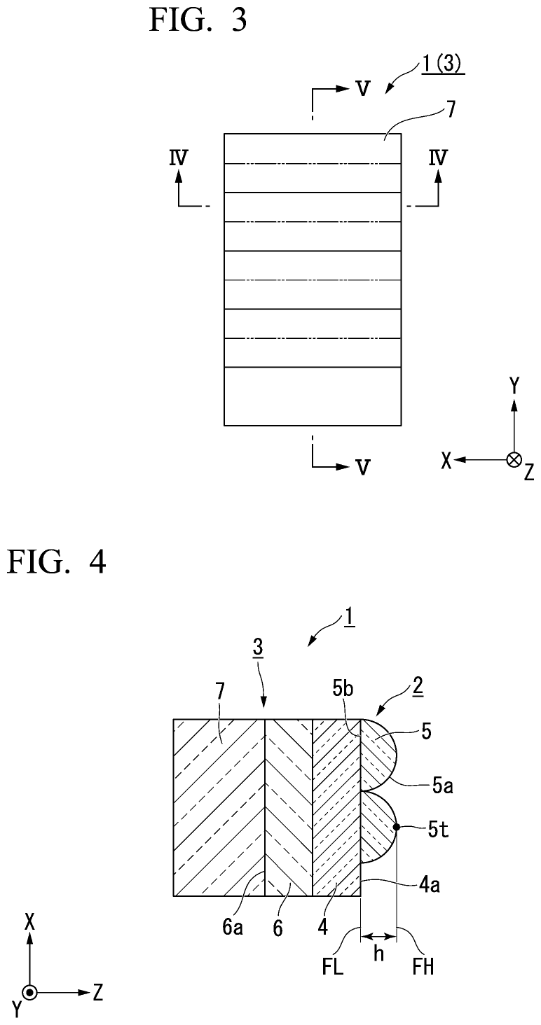

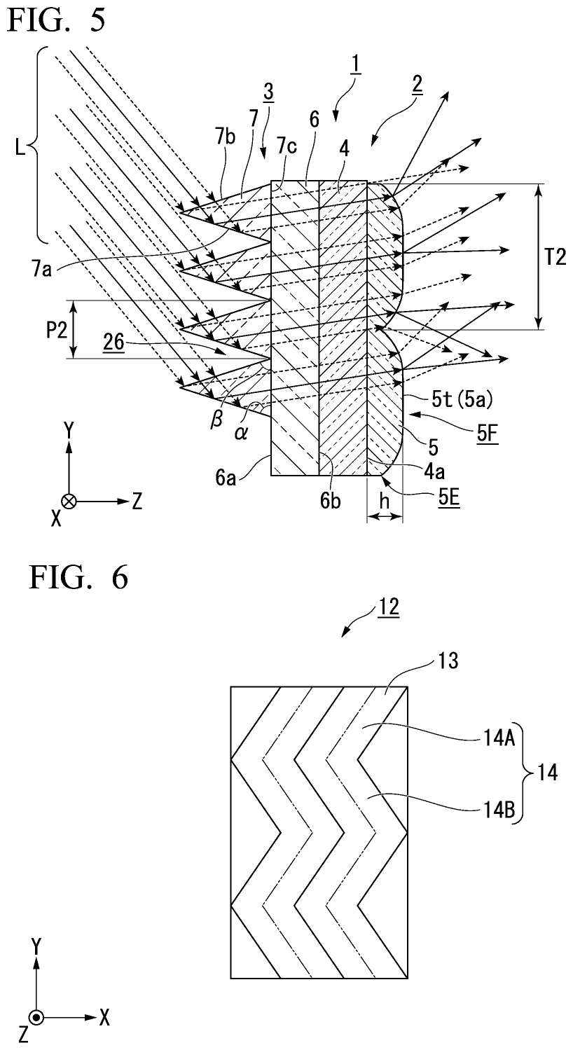

FIG. 1 is a perspective view of a daylighting device in accordance with the first embodiment. FIG. 2 is a front view of the daylighting device. FIG. 3 is a rear view of the daylighting device. FIG. 4 is a cross-sectional view of the daylighting device, taken along line IV-IV shown in FIGS. 2 and 3. FIG. 5 is a cross-sectional view of the daylighting device, taken along line V-V shown in FIGS. 2 and 3.

Throughout the following description, the directional designations such as “upper,” “lower,” “top,” “bottom,” “left,” “right,” “front,” and “back” in and around a daylighting device are given as they would be from the point of view of a user in the room. Unless otherwise specified, these designations in the description match those in and around the daylighting device on the pages on which the daylighting device is drawn.

In the drawings used in the following description, members may be drawn to different scales so that they are readily recognizable.

Referring to FIG. 1, a daylighting device 1 in accordance with the present embodiment includes a light-diffusion film 2 (light-diffusion member) and a daylighting film 3 (daylighting member). The light-diffusion film 2 includes a first base member 4 and a plurality of cylindrical lenses 5 that is provided on a first face 4a of the first base member 4. The daylighting film 3 includes a second base member 6 and a plurality of daylighting sections 7 that is provided on a first face 6a of the second base member 6. The light-diffusion film 2 and the daylighting film 3 are attached together in such a manner that a second face 4b of the first base member 4 faces a second face 6b of the second base member 6 and that the cylindrical lenses 5 are perpendicular to the daylighting sections 7. In other words, the direction in which the daylighting sections 7 are arrayed crosses the direction in which the cylindrical lenses 5 are arrayed. The first base member 4 and the second base member 6 may be provided as a single, common base member. More specifically, the single base member may have: a plurality of daylighting sections formed on one side thereof; and a plurality of cylindrical lenses formed on the other side.

The light-diffusion film 2 includes: the first base member 4 which is transparent to visible light; and the cylindrical lenses 5 which are provided on the first face 4a of the first base member 4. The first base member 4 serves as a supporting member for supporting the cylindrical lenses 5. The direction in which the cylindrical lenses 5 are arrayed is designated as a first direction (X-direction). The direction perpendicular to the first direction when viewed normal to the first face 4a of the first base member 4 is designated as a second direction (Y-direction). A normal to the first face 4a is designated as a third direction (Z-direction).

The first base member 4 is, for example, a transparent base member composed of a thermoplastic polymer, a thermosetting resin, a photopolymerizable resin, or a like resin. In particular, the transparent base member may be composed primarily of an acrylic-based polymer, an olefin-based polymer, a vinyl-based polymer, a cellulose-based polymer, an amide-based polymer, a fluorine-based polymer, a urethane-based polymer, a silicone-based polymer, or an imide-based polymer. Preferably used among these examples are transparent board members composed primarily of, for example, triacetyl cellulose (TAC), polyethylene terephthalate (PET), cycloolefin polymer (COP), polycarbonate (PC), polyethylene naphthalate (PEN), polyether sulfone (PES), or polyimide (PI). The first base member 4 may alternatively be a glass base member. The first base member 4 may have any suitable thickness. As a further alternative, the first base member 4 may include layers of different materials. The first base member 4 preferably has a total light transmittance of 90% or higher when measured as specified in JIS K7361-1, which may give sufficient transparency.

Each cylindrical lens 5 has a general shape of a columnar structural body, such as a cylinder or an elliptical cylinder, cut along a plane parallel to the central axis thereof. Therefore, the cylindrical lens 5 has, for example, a generally semicircular cross-section if it is taken perpendicular to the length thereof as shown in FIG. 4. The cylindrical lens 5 hence has a curved lens surface 5a and a plane 5b.

The line that passes through the apex of the generally semicircular cross-section of the cylindrical lens and that runs along the entire length of the cylindrical lens will be referred to as the ridge line throughout the following description. In addition, in reference to FIG. 4, calling the lowest place between adjacent cylindrical lenses 5 a groove, an imaginary plane that contains such grooves and that is parallel to the XY-plane will be designated as a bottom face FL of the cylindrical lenses, and an imaginary plane that contains the ridge lines and that is parallel to the XY-plane will be designated as a top face FH of the cylindrical lenses. The distance in the Z-direction from the bottom face FL to the top face FH is designated as the height h of the lens surface of the cylindrical lens.

As shown in FIG. 2, the cylindrical lenses 5 have the same shape and are arrayed in the first direction (X-direction). Each cylindrical lens 5 is generally extended in the second direction (Y-direction) when viewed normal to the first face 4a of the first base member 4. The cylindrical lens 5 is however not linearly extended and has a zigzagging ridge line 5t. Put differently, the cylindrical lens 5 has some segments extended out of alignment with a perpendicular to the first direction (X-direction), but the general direction in which the cylindrical lens 5 is extended as a whole is designated as the second direction (Y-direction).

The cylindrical lens 5 has a width in the first direction (X-direction), and the width is substantially constant anywhere along the length of the cylindrical lens 5. The cylindrical lens 5 has a height that is substantially constant anywhere across the cylindrical lens 5. In the present embodiment, the lens surface 5a of the cylindrical lens 5 has a height that is equal to a distance from the first face 4a of the first base member 4 to the ridge line 5t of the lens surface 5a and that is equivalent to a maximum difference in the changing height of the cylindrical lens 5 as traced along the X-direction.

Although, for instance, FIGS. 2 and 4 show only two cylindrical lenses 5, there are provided more cylindrical lenses 5 in reality.

Again in reality, the lens surface of the cylindrical lens is a curved, smooth surface and therefore has no clearly recognizable ridge line. In the front views of the cylindrical lens in FIG. 2 and other figures, however, a single line (dash-dot line) is used to indicate the direction in which the ridge line is extended for easy understanding.

In the present embodiment, the cylindrical lens 5 includes a plurality of bending sections 9 arrayed end to end in the second direction. Each bending section 9, which is a repeating unit, includes: a first inclined section 9A that is, in FIG. 2, tilted with respect to the second direction and extended obliquely from the upper right toward the lower left; a straight section 9B that is, in FIG. 2, extended parallel to the second direction; and a second inclined section 9C that is, in FIG. 2, tilted with respect to the second direction and extended obliquely from the upper left toward the lower right. These first inclined section 9A, straight section 9B, and second inclined section 9C are formed integrally.

In the bending section 9 of the cylindrical lens 5, the first inclined section 9A is extended in a direction that makes angle η1 with the second direction. Angle η1 is set to smaller than 45° because if angle ill is set to greater than or equal to 45°, the cylindrical lens 5 is, in effect, no longer extended in the second direction as a whole and can very poorly diffuse the light exiting the daylighting film 3 horizontally into the room. Angle η1 is more preferably set, for example, approximately to from 0.8° to 22°. If angle η1 is less than 0.8°, the cylindrical lens 5 may fail to sufficiently mingle dispersed light, possibly allowing colored light to leave the cylindrical lens 5. If angle η1 is greater than 22°, the cylindrical lens 5 may fail to sufficiently diffuse light in horizontal directions, and the daylighting film 3 may not be sufficiently anisotropic. All these descriptions apply to angle η2 made between the second direction and the direction in which the second inclined section 9C is extended, as well as to angle η1.

The following will describe variation examples of the cylindrical lens 5.

FIG. 6 is a front view of a daylighting device 12 in accordance with a first variation example.

The cylindrical lens 5 does not necessarily include the straight section 9B extended parallel to the second direction. Referring to FIG. 6, a cylindrical lens 13 in accordance with the first variation example includes a plurality of bending sections 14. Each bending section 14, which is a repeating unit, includes: a first inclined section 14A that is tilted with respect to the second direction (Y-direction) and extended obliquely from the upper right toward the lower left; and a second inclined section 14B that is tilted with respect to the second direction and extended obliquely from the upper left toward the lower right. These first inclined section 14A and second inclined section 14B are formed integrally.

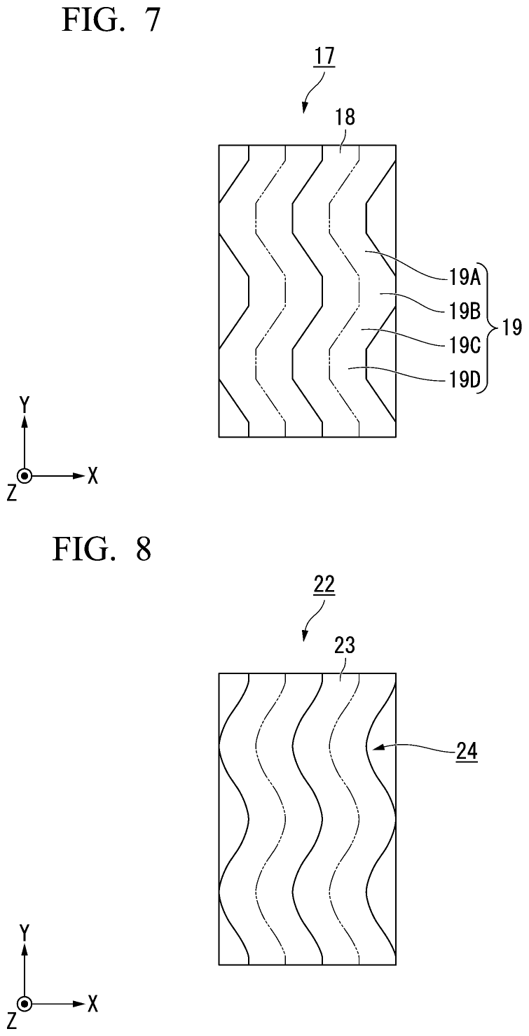

FIG. 7 is a front view of a daylighting device 17 in accordance with a second variation example. Referring to FIG. 7, a cylindrical lens 18 in accordance with the first variation example includes a plurality of bending sections 19. Each bending section 19, which is a repeating unit, includes: a first inclined section 19A that is tilted with respect to the second direction and extended obliquely from the upper left toward the lower right; a first straight section 19B that is extended parallel to the second direction; a second inclined section 19C that is tilted with respect to the second direction and extended obliquely from the upper right toward the lower left; and a second straight section 19D that is extended parallel to the second direction. These first inclined section 19A, first straight section 19B, second inclined section 19C, and second straight section 19D are formed integrally.

FIG. 8 is a front view of a daylighting device 22 in accordance with a third variation example.

The cylindrical lenses are not necessarily bent with clear corners. Referring to FIG. 8, a cylindrical lens 23 in accordance with the third variation example includes a plurality of curved sections 24. Each curved section 24, which is a repeating unit, includes a gently curved section that swells to the right or to the left.

The cylindrical lenses 5, 13, 18, and 23 respectively include the bending sections 9, 14, and 19 and the curved section 24 in the first embodiment and variation examples as described above. Therefore, even if the lens surface 5a has a substantially constant height across the length of the cylindrical lenses 5, 13, 18, and 23, the height continuously changes with a prescribed period, as shown in FIG. 5, when viewed in a cross-section (that is perpendicular to the X-direction) of the cylindrical lens 5 taken along a second imaginary plane (plane of the paper) that is both parallel to the second direction (Y-direction) and perpendicular to a first imaginary plane (XY-plane) containing both the first direction (X-direction) and the second direction (Y-direction). Since the cylindrical lenses 5, 13, 18, 23 include a repetition of identical bending sections 9, 14, and 19 and curved sections 24 respectively, the height of the lens surface 5a changes with a particular period.

The language, “the height of the lens surface continuously changes with a prescribed period,” does not refer to discrete changes of the height, that is, does not refer to a stepwise cross-section of the lens surface taken perpendicular to the first direction, but means that the lens surface has an inclined section where the height of the lens surface continuously (gently) changes when traced along the second direction and also that such an inclined section is repeated. The inclined section of the lens surface may be tilted in a linear manner or in a curved manner with respect to the bottom face when observed in a cross-section perpendicular to the first direction.

The cylindrical lenses 5, 13, 18, and 23 may be composed of a different material than is the first base member 4 and are preferably composed of the same material as is the first base member 4. When the cylindrical lenses 5, 13, 18, and 23 are composed of a different material than is the first base member 4, the cylindrical lenses 5, 13, 18, and 23 preferably have a refractive index that is approximately equal to the refractive index of the first base member 4.

The cylindrical lenses 5, 13, 18, and 23 may include a light-scattering member therein. Specifically, inside the cylindrical lenses 5, 13, 18, and 23, there may be provided light-scattering particles that have a different refractive index from the refractive index of the material of which the cylindrical lens base material is composed. The light-scattering particles may have a size that is smaller than the curvature of the cylindrical lens.

Alternatively, the cylindrical lenses 5, 13, 18, and 23 may have, on the lens surface thereof, a light-scattering structure composed of tiny irregularities. The irregularities have a size that is smaller than the curvature of the cylindrical lens. If the cylindrical lenses 5, 13, 18, and 23 adopt any of these structures, they exhibit improved light-scattering ability and provide a means of adjusting a light-scattering level.

The second base member 6 is composed of a material that is transparent to visible light. The second base member 6 may be composed of a different material than is the first base member 4 and is preferably composed of the same material as is the first base member 4. When the second base member 6 is composed of a different material than is the first base member 4, the second base member 6 preferably has a refractive index that is approximately equal to the refractive index of the first base member 4. The second base member 6 serves as a supporting member for supporting the daylighting sections 7. The second base member 6 and the first base member 4 may be provided as a single, common base member. In other words, the daylighting sections 7 may be provided directly on a face of the first base member that is opposite the face thereof on which the cylindrical lenses are provided.

Referring to FIG. 5, the daylighting sections 7 are disposed on the first face 6a of the second base member 6. All the daylighting sections 7 are transparent and have the same shape and dimensions. A gap portion 26 is a space between two adjacent daylighting sections 7 and contains air. Although FIGS. 3 and 5 show only four daylighting sections 7, there are provided more daylighting sections 7 in reality.

The daylighting sections 7 are composed of, for example, a light-transmitting and photosensitive organic material such as an acrylic resin, an epoxy resin, or a silicone resin. These organic resins may be mixed with, for example, a polymerization initiator, a coupling agent, a monomer, or an organic solvent for use. The polymerization initiator may contain various additional components such as a stabilizer, an inhibitor, a plasticizer, a fluorescent whitening agent, a release agent, a chain transfer agent, and/or another photopolymerizable monomer. Those materials described in Japanese Patent No. 4129991 may also be used for the daylighting sections 7. The daylighting sections 7 preferably have a total light transmittance of 90% or greater when measured as specified in JIS K7361-1, which may give sufficient transparency.

Referring to FIGS. 1 and 5, each daylighting section 7 is a transparent structural body shaped like a triangular prism and extended in the first direction (X-direction). In other words, the daylighting section 7 is triangular in a cross-section thereof taken perpendicular to the length thereof. The daylighting sections 7 are arrayed in the second direction (Y-direction). The daylighting section 7 changes the traveling direction of incoming sunlight in a vertical plane (YZ-plane) to guide it indoors. The daylighting section 7 does not necessarily have a shape that resembles a triangular prism and may be shaped, for example, like any other polygonal (non-triangular) prism.

The daylighting section 7 has: a first face 7a serving primarily as a reflection face that reflects off incident light; a second face 7b serving primarily as an entrance face on which sunlight is incident; and a third face 7c that is in contact with the first face 6a of the second base member 6. Letting a denote an angle between the first face 6a of the second base member 6 and the first face 7a of the daylighting section 7 and β denote an angle between the first face 6a of the second base member 6 and the second face 7b of the daylighting section 7, it then follows that angle α is approximately from 60° to 90° and that angle β is approximately from 50° to 89°. Angle α may be and may not be equal to angle β.

Sunlight L, after passing through window glass, may possibly take various paths between the entrance to the daylighting section 7 and the exit from the second base member 6. A typical path is shown in FIG. 5. Referring to FIG. 5, sunlight L, after passing through window glass (not shown), enters the daylighting section 7 through the second face 7b, reflects off the first face 7a, then enters the second base member 6, and exits the second base member 6 through the second face 6b.

In this example, there exists air between adjacent daylighting sections 7. These air-containing portions form the gap portions 26. In an alternative structure, the portions between adjacent daylighting sections 7 may be filled with a low-refractive-index material other than air. However, the difference in refractive index at the interface between the daylighting section 7 and the gap portion 26 is a maximum when there is air in the gap portion 26 than when there is any other low-refractive-index material in the gap portion 26. That, according to Snell's law, means that the critical angle for light on the first face 7a is a minimum when there is air in the gap portion 26 between adjacent daylighting sections 7.

When there is air in the gap portion 26, the range of the angle of incidence of light L that is totally reflected off the first face 7a becomes broadest, and the light incident to the daylighting section 7 is efficiently guided to the second face 6b side of the second base member 6. This restrains loss of light L incident to the daylighting section 7 and increases the intensity of light exiting the second base member 6 through the second face 6b.

The refractive index of the second base member 6 is preferably substantially equal to the refractive index of the daylighting sections 7. In other words, the second base member 6 and the daylighting sections 7 are preferably formed integrally as a single member. For example, if the refractive index of the second base member 6 differs much from the refractive index of the daylighting sections 7, light L, upon entering the second base member 6 from the daylighting sections 7, may be undesirably refracted or reflected at the interface between the daylighting sections 7 and the second base member 6. When this is actually the case, problems could occur including reduced luminance and a failure to achieve desired daylighting properties.

Light L, upon exiting the second base member 6 of the daylighting film 3, enters the light-diffusion film 2. Light L is then diffused by the cylindrical lenses 5 and emitted into the indoor space.

A description is now given of problems of the conventional daylighting device and advantages of the daylighting device of the present embodiment.

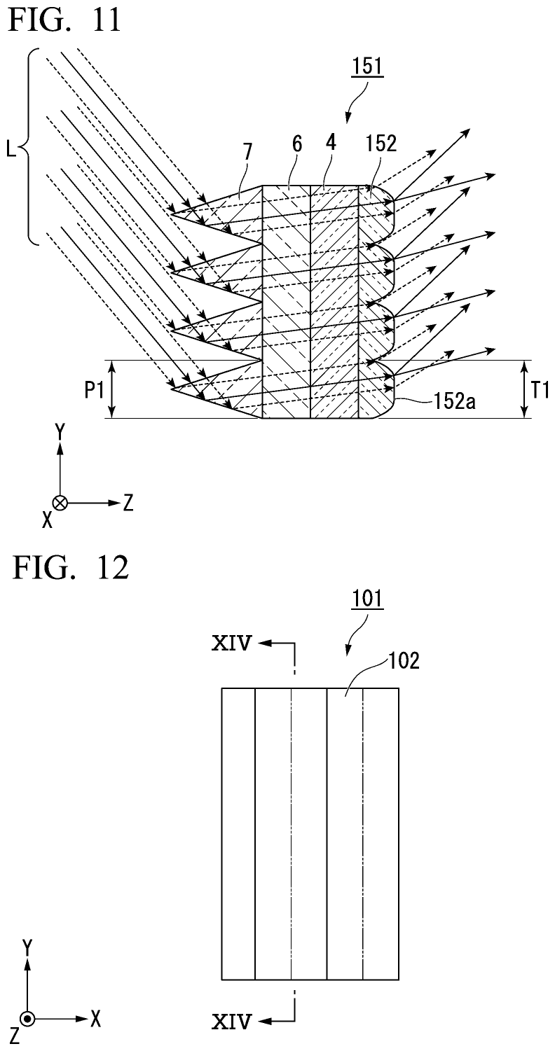

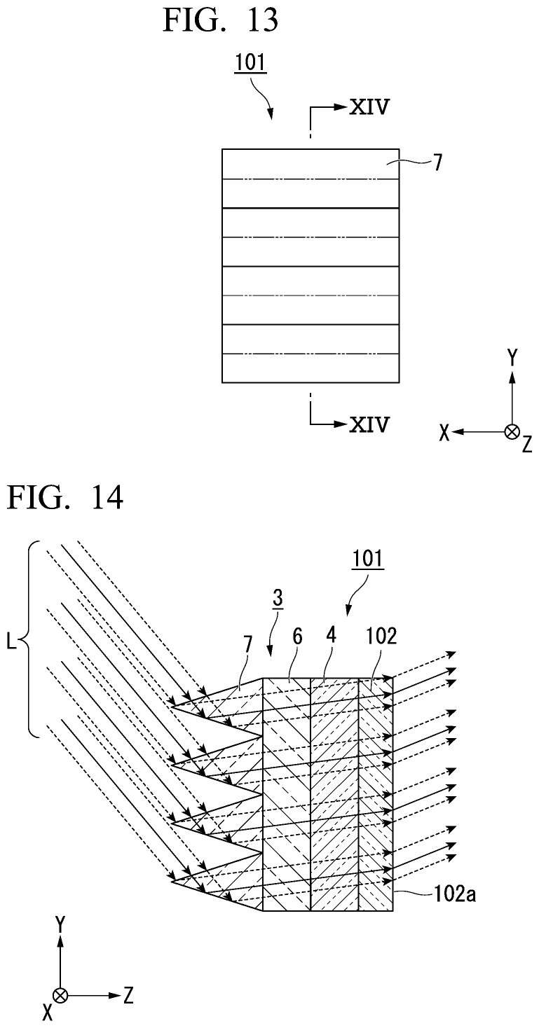

FIG. 12 is a front view of a conventional daylighting device 101. FIG. 13 is a rear view of the conventional daylighting device 101. FIG. 14 is a cross-sectional view of the conventional daylighting device 101, taken along line XIV-XIV shown in FIGS. 12 and 13.

Referring to FIG. 12, cylindrical lenses 102 are linearly extended parallel to the second direction (Y-direction) in the conventional daylighting device 101. In such cases, as shown in FIG. 14, the cylindrical lens 102 has a lens surface 102a that has a zero curvature in the YZ-plane (vertical plane), which translates into the inability of the cylindrical lens 102 to refract light in the YZ-plane (vertical plane). The light exiting the daylighting film 3 therefore passes through the cylindrical lens 102 without being diffused. The light exits the cylindrical lens 102 with the same angle distribution that the light has upon exiting the daylighting film 3.

Sunlight L contains various wavelength components. Additionally, the resin of which a prismatic structural body is composed exhibits different refractive indices depending on the wavelength. Sunlight L is therefore dispersed in the YZ-plane (vertical plane) when passing through the daylighting section 7 which is a prismatic structural body. Since the cylindrical lens 102 has no ability to refract light in the YZ-plane (vertical plane) as described above, the dispersed light exits the daylighting device 101 without being refracted. As a result, the light reaching the inside of the room is colored, failing to deliver white light suitable for general lighting.

In contrast, in the daylighting device 1 of the present embodiment, unlike in the conventional daylighting device 101, the lens surface 5a of the cylindrical lens 5 includes: an inclined section 5E where the lens surface 5a has a continuously changing height; and a straight section 5F where the lens surface 5a has a constant height, as shown in FIG. 5. Due to these changes in the height of the lens surface 5a, the cylindrical lens 5 has an ability to refract light in the YZ-plane (vertical plane). Sunlight L exits the cylindrical lens 5 at different angles depending on where sunlight L hits on the lens surface 5a. That translates into an ability of the cylindrical lens 5 of the present embodiment to diffuse light in the YZ-plane (vertical plane) as well as in the XZ-plane (horizontal plane). Therefore, the light dispersed by one of the daylighting sections 7 is mingled with the light dispersed by another one of the daylighting sections 7, which produces whitish light.

As described earlier, the lens surface 5a of the cylindrical lens 5 has a height that changes with a particular period, and the daylighting sections 7 are arrayed with a particular period. The period of the changing height of the lens surface 5a preferably differs from the array period of the daylighting sections 7 in the daylighting device 1 in accordance with the present embodiment for the following reasons.

A daylighting device in which the period of the changing height of the lens surface is equal to the array period of the daylighting sections is taken up as a comparative example of the daylighting device.

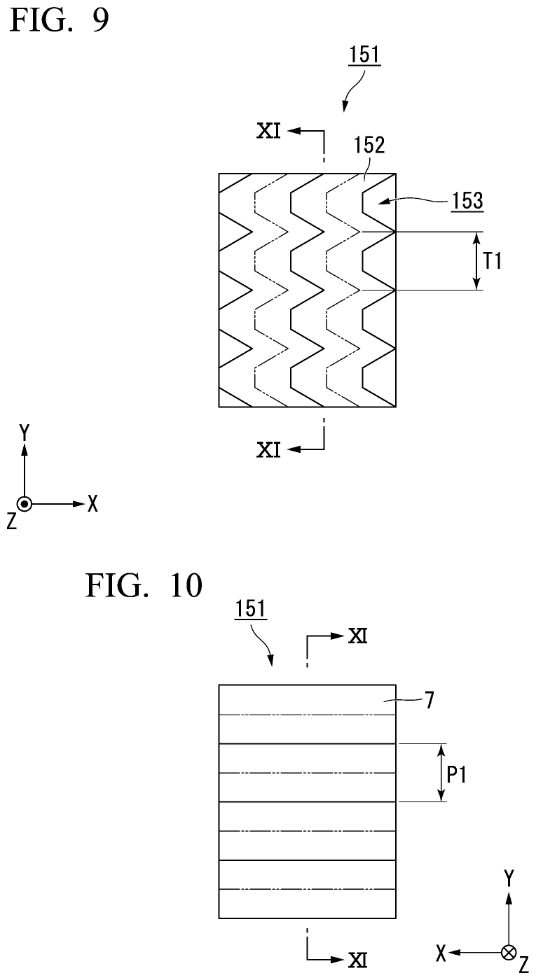

FIG. 9 is a front view of a daylighting device 151 in accordance with the comparative example. FIG. 10 is a rear view of the daylighting device 151 in accordance with the comparative example. FIG. 11 is a cross-sectional view of the daylighting device 151 in accordance with the comparative example, taken along line XI-XI shown in FIGS. 9 and 10.

Referring to FIGS. 9 to 11, in the daylighting device 151 in accordance with the comparative example, the daylighting sections 7 have a pitch P1 (array period) that is equal to the period of repeating bending sections 153 of each cylindrical lens 152 (the length of the bending section 153 as measured in the second direction (Y-direction)), that is, the period of the changing height T1 of a lens surface 152a. The light having passed through one of the daylighting sections 7 and the light having passed through another one of the daylighting sections 7 pass through different parts of the cylindrical lens 152 where the lens surface 152a has substantially the same angle of inclination, thereby exiting the cylindrical lens 152 at substantially equal angles and being hardly mingled.

In contrast, if the period T1 of the changing height of the lens surface 5a differs from the array period P1 of the daylighting sections 7 as shown in FIG. 5 as is the case with the daylighting device 1 in accordance with the present embodiment, the light having passed through one of the daylighting sections 7 and the light having passed through another one of the daylighting sections 7 pass through different parts of the cylindrical lens 5 where the lens surface 5a has different angles of inclination, thereby exiting the cylindrical lens 5 at different angles and being likely mingled. Therefore, the daylighting device 1, in which the changing height of the lens surface 5a has a period T2 that differs from an array period P2 of the daylighting sections 7, can deliver light that is more whitish. Note that P2 is preferably smaller than T2 as shown in FIG. 5 because there are limits on the bending period of the lenticular lens.

The daylighting device 1 in accordance with the present embodiment may be modified as in the diverse variation examples detailed below.

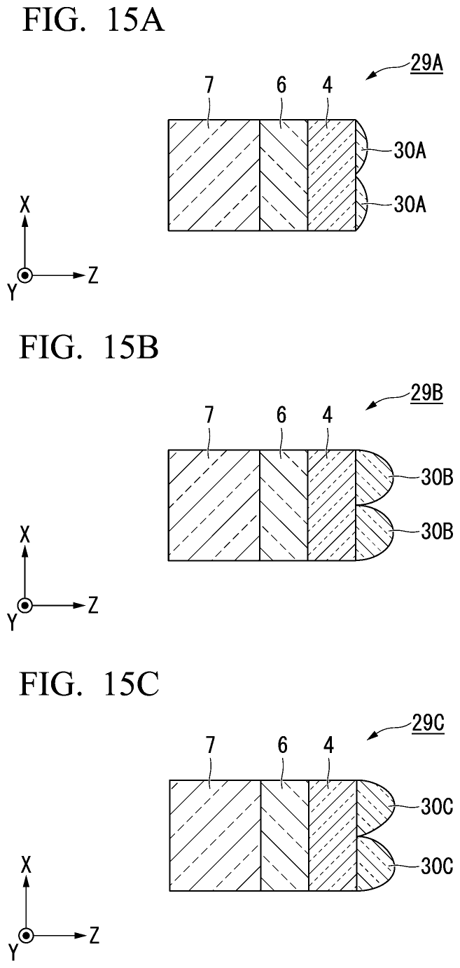

FIG. 15A is a cross-sectional view of a daylighting device 29A in accordance with a fourth variation example. FIG. 15A shows only two of multiple cylindrical lenses 30A.

The cylindrical lens 30 does not necessarily have a semicircular cross-section. Referring to FIG. 15A, in the daylighting device 29A in accordance with the fourth variation example, the cylindrical lens 30A has a cross-section obtained by dissecting a cylinder along a plane that is parallel to the central axis of the cylinder without passing through the center of the circle.

In an alternative daylighting device 29B shown in FIG. 15B, a cylindrical lens 30B may have a cross-section that is shaped like a part of an ellipse rather than like a part of a circle. As a further alternative, the daylighting device 29B may include a mixed combination of cylindrical lenses of different cross-sectional shapes, for example, those resembling a part of a circle and those resembling a part of an ellipse. In another alternative daylighting device 29C shown in FIG. 15C, a cylindrical lens 30C may have an asymmetric cross-section. The use of such an asymmetric cylindrical lens 30C produces an asymmetric luminance distribution.

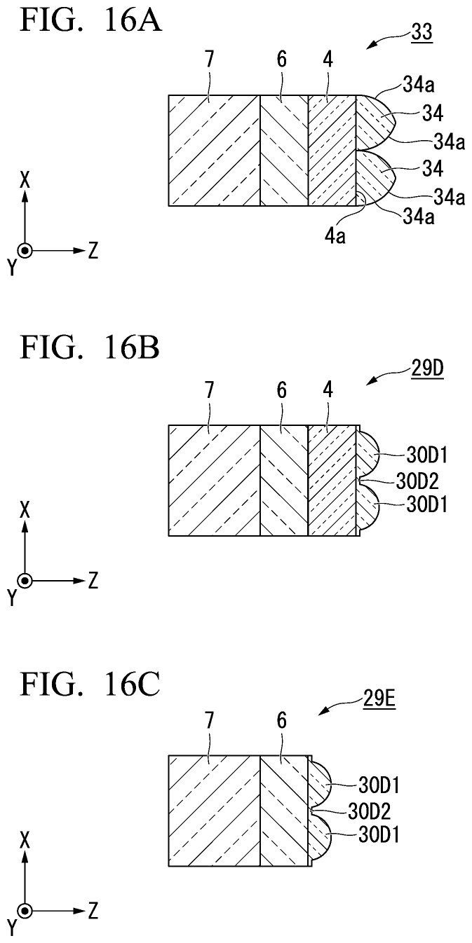

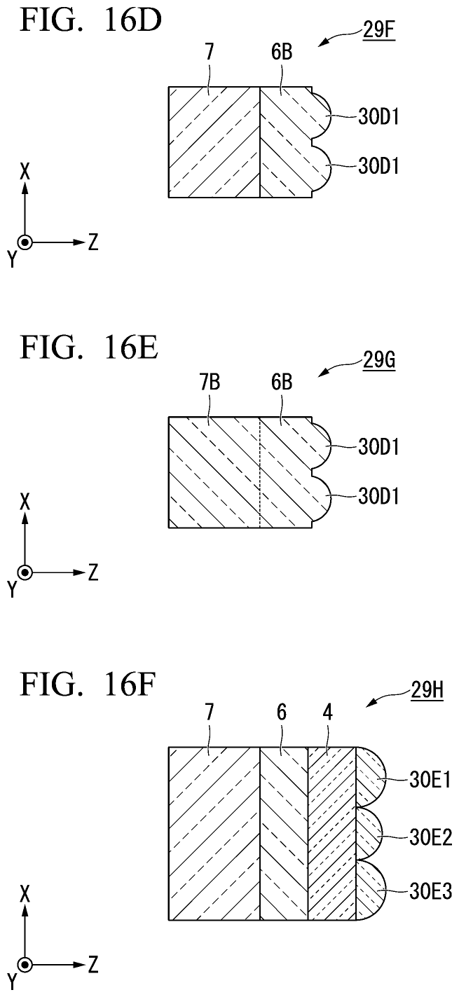

FIG. 16A is a cross-sectional view of a daylighting device 33 in accordance with a fifth variation example.

A cylindrical lens 34 does not necessarily have a cross-section that is entirely shaped smoothly like a part of a circle. In the daylighting device 33 in accordance with the fifth variation example, the cylindrical lens 34, as shown in FIG. 16A, has no face that is generally parallel to the first face 4a of the first base member 4. More specifically, the cylindrical lens 34 has a cross-section with a pointed apex obtained by disposing a pair of left and right curved lens surfaces 34a in a symmetric manner with respect to the central axis.

FIG. 16B is a cross-sectional view of a daylighting device 29D in accordance with a sixth variation example.

Referring to FIG. 16B, in the daylighting device 29D in accordance with the sixth variation example, cylindrical lenses 30D1 are not separated from each other. Instead, adjacent cylindrical lenses 30D1 are coupled by a coupling section 30D2. The cylindrical lens 30D1 side of this daylighting device 29D can be fabricated by a method such as UV transfer or printing (details will be given later), and the daylighting section 7 (prismatic structural body) side thereof can be fabricated by UV transfer.

FIG. 16C is a cross-sectional view of a daylighting device 29E in accordance with a seventh variation example.

The daylighting device 29E does not necessarily include two base members.

Referring to FIG. 16C, in the daylighting device 29E in accordance with the seventh variation example, the cylindrical lenses 30D1 are formed directly on the second base member 6. The single base member is a second base member 6, but may be a first base member 4, in this example. The cylindrical lens 30D1 side of this daylighting device 29E can be fabricated by a method such as UV transfer or printing (details will be given later), and the daylighting section 7 (prismatic structural body) side thereof can be fabricated by UV transfer.

FIG. 16D is a cross-sectional view of a daylighting device 29F in accordance with an eighth variation example.

The daylighting device 29F does not necessarily include a base member separately from cylindrical lenses. Referring to FIG. 16D, in the daylighting device 29F in accordance with the eighth variation example, the cylindrical lenses 30D1 and a base member section 6B are integrated into a single member. The cylindrical lens 30D1 side of this daylighting device 29F can be fabricated by extrusion molding transfer (details will be given later), and the daylighting section 7 (prismatic structural body) side thereof can be fabricated by UV transfer.

FIG. 16E is a cross-sectional view of a daylighting device 29G in accordance with a ninth variation example.

The light-diffusion film and the daylighting film are not necessarily provided separately. Referring to FIG. 16E, in the daylighting device 29G in accordance with the ninth variation example, the cylindrical lenses 30D1, the base member section 6B, and daylighting sections 7B are integrated into a single member. In other words, the daylighting device 29G has both a daylighting function and a light-diffusing function. The cylindrical lens 30D1 side and the daylighting section 7B (prismatic structural body) side of this daylighting device 29G can be fabricated simultaneously by extrusion molding transfer.

FIG. 16F is a cross-sectional view of a daylighting device 29H in accordance with a tenth variation example.

The cylindrical lenses do not necessarily have a constant array period. Referring to FIG. 16F, in the daylighting device 29H in accordance with the tenth variation example, cylindrical lenses 30E1, 30E2, and 30E3 have a variable array period. In other words, the cylindrical lenses 30E1, 30E2, and 30E3 have mutually different widths and are arrayed in a random manner. This arrangement of cylindrical lenses with different widths can additionally restrain the coloring that would be caused by the horizontal dispersion of light by cylindrical lenses arrayed with a constant array period.

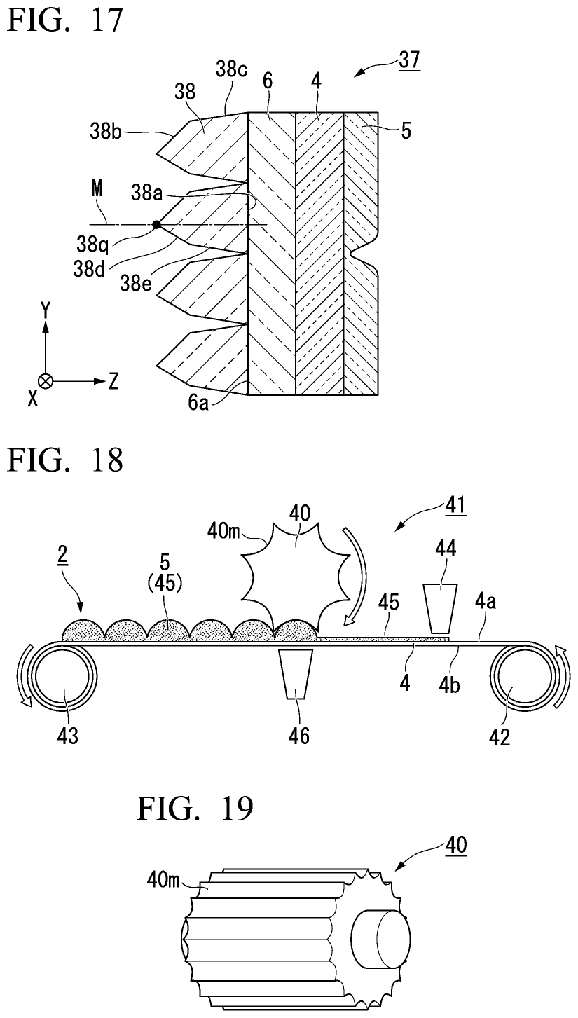

FIG. 17 is a cross-sectional view of a daylighting device 37 in accordance with an eleventh variation example.

The daylighting section is not necessarily shaped like a triangular prism. Referring to FIG. 17, in the daylighting device 37 in accordance with the eleventh variation example, each daylighting section 38 is a prismatic structural body shaped like a pentagonal prism. In other words, the daylighting section 38 has a cross-section, taken perpendicular to the length thereof, that is a pentagon having five vertices with all interior angles being smaller than 180°.

Specifically, the daylighting section 38 is a prismatic structural body with a pentagonal cross-section and has an asymmetric shape with respect to line M that is perpendicular to a face 38a of the daylighting section 38 and that passes through a vertex 38q located most remotely from the face 38a, the face 38a being in contact with the first face 6a of the second base member 6. In other words, the daylighting section 38 has a lower portion that contains a face (reflection face) 38d and a face (reflection face) 38e and an upper portion that contains a face 38b and a face 38c, and the lower portion has a larger volume than the upper portion. The daylighting section 38 is provided such that the daylighting section 38 is divided into two portions by line M perpendicular to the face 38a and that one of the two portions of the daylighting section 38 that has a larger volume (a portion that contains the face 38d and the face 38e) is located lower than the other portion.

Next will be described some examples of how the light-diffusion film 2 in accordance with the present embodiment is manufactured.

It should be noted however that the light-diffusion film 2 is not necessarily manufactured by one of the example methods described below.

### UV Transfer

First, a metal molding roll 40 is prepared by mechanical cutting as shown in FIG. 19. The metal molding roll 40 has concave grooves 40m, each having a curved face, that are arranged next to each other when traced along the circumference of the metal molding roll 40.

Next, as shown in FIG. 18, the first base member 4 is moved from an unwind roll 42 toward a winding roll 43 by using a roll-to-roll transporter 41. The first base member 4 is transparent to the light having wavelengths used in resin curing (UV light) (details will be given later). A resin applicator 44 located above the first base member 4 applies a photocuring resin 45 onto the first face 4a of the first base member 4 during the transport. The photocuring resin 45 is a component material for the cylindrical lenses 5.

Light from resin curing equipment 46 is then shone onto the second face 4b side of the first base member 4 while the first base member 4 to which the photocuring resin 45 has been applied is being pressed against the metal molding roll 40. This step transfers the concave grooves 40m on the metal molding roll 40, which have a negative shape for the cylindrical lenses 5, from the metal molding roll 40 onto the photocuring resin 45 and cures the photocuring resin 45. That completes the manufacture of a roll of light-diffusion film 2 carrying thereon the cylindrical lenses 5 arranged next to each other when traced along the direction of travel of the first base member 4.

### Extrusion Molding Transfer

First, as is the case with the transfer method, a metal molding roll 40 is prepared that has concave grooves 40m, each having a curved face, that are arranged next to each other when traced along the circumference.

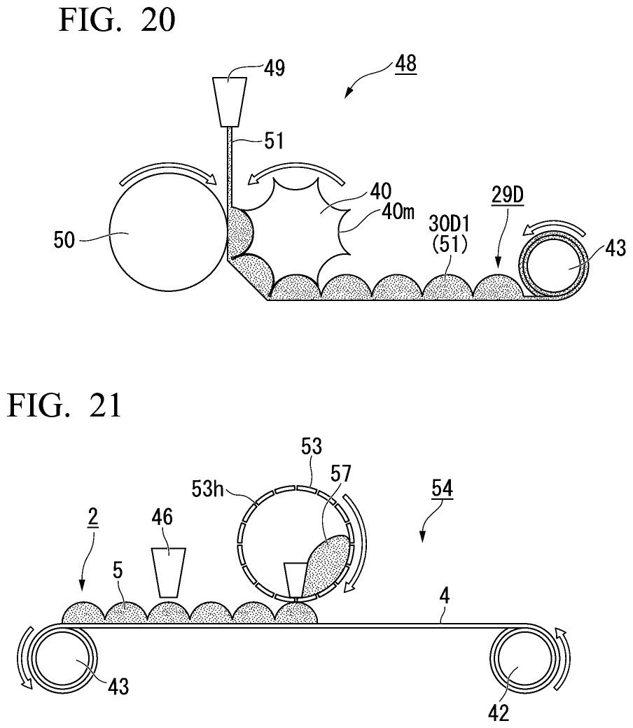

Next, as shown in FIG. 20, in an extrusion molder 48, a resin 51, which is a starting material for the cylindrical lenses 5, is supplied by a resin dispenser 49 and wound by the winding roll 43. In this step, the resin 51, which is supplied from the resin dispenser 49 in molten form, is cooled while being passed between the metal molding roll 40 and a press roll 50. This step transfers the concave grooves 40m on the metal molding roll 40, which have a negative shape for the cylindrical lenses 5, from the metal molding roll 40 onto the resin 51 and cures the resin 51 by cooling the resin 51. That completes the manufacture of a roll of daylighting device 29D carrying thereon the cylindrical lenses 30D1 arranged next to each other when traced along the direction of travel.

The press roll 50 may have formed in the surface thereof grooves arranged next to each other when traced along the circumference of the press roll 50, the grooves being a negative of a prismatic structure. Such a press roll 50 enables simultaneous formation of the prismatic structure on a surface of the first base member 4 that is opposite to the surface thereof on which the cylindrical lenses are formed.

### Rotary Screen Printing

First, a pattern is drawn by laser on an emulsion-applied roll surface and then developed, to prepare a rotary mesh screen 53 having an opening pattern 53h.

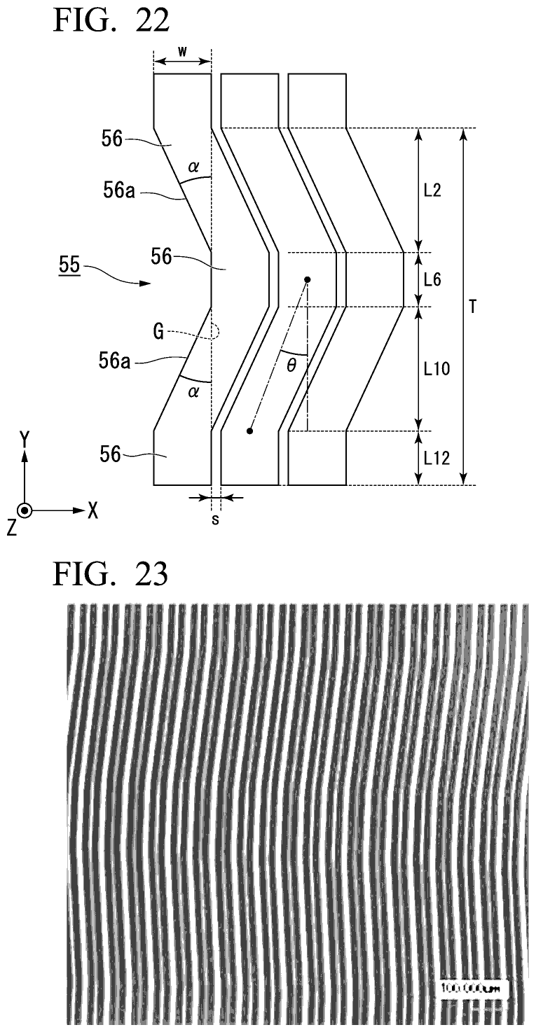

Next, as shown in FIG. 21, in a screen printer 54, resin ink 57, which is a starting material for the cylindrical lenses 5, is supplied to the inside of the rotary mesh screen 53 and transferred through the opening pattern 53h of the rotary mesh screen 53 onto the first base member 4. Thereafter, the applied ink 57 forms a convex cross-section as a precursor of the cylindrical lens by the surface tension thereof and cures under ultraviolet light and/or heat from the resin curing equipment 46. That completes the manufacture of a roll of light-diffusion film 2 carrying thereon the cylindrical lenses 5 arranged next to each other when traced along the direction in which the first base member 4 is transported.

The inventors of the present invention actually manufactured prototype light-diffusion films 2 in accordance with the present embodiment and evaluated the light-diffusion properties thereof as described below.

The inventors manufactured prototype light-diffusion films in accordance with the examples of the invention. Each of the prototype light-diffusion films, as described above, includes a plurality of cylindrical lenses that in turn include bending sections. Three patterns A, B, and C of unit straight sections were prepared as example shapes of the bending sections as shown in Table 1 below.

A unit straight section is an individual one of straight sections making up a bending section 9 that resembles a bent line.

FIG. 22 shows a bending section 55 in pattern A.

TABLE 1

| | | Angle α (°) of | | | |
|---|---|---|---|---|---|
| | | Unit Straight | Pattern | Pattern | Pattern |
| | | Section | A | B | C |
| Number of Unit Straight Sections in a | | | 4 | 8 | 12 |
| Bending Section | | | | | |
| Period T (μm) of Bending Sections | | | 1020 | 1016 | 1020 |
| Dimension (μm) | L1 | −2.5 | — | 127 | 85 |
| of Unit Straight | L2 | −5 | 340 | — | 85 |
| Section | L3 | −7.5 | — | — | 85 |
| | L4 | −5 | — | 127 | 85 |
| | L5 | −2.5 | — | 127 | 85 |
| | L6 | 0 | 170 | 127 | 85 |
| | L7 | 2.5 | — | 127 | 85 |
| | L8 | 5 | — | 127 | 85 |
| | L9 | 7.5 | — | — | 85 |
| | L10 | 5 | 340 | — | 85 |
| | L11 | 2.5 | — | 127 | 85 |
| | L12 | 0 | 170 | 127 | 85 |

In Table 1, the number of unit straight sections 56 refers to the number of unit straight sections 56 in a single bending section 55. Therefore, the bending section 55 shown in FIG. 22, having pattern A, has four unit straight sections 56. The repeating period T of the bending section 55 is the entire length of the bending section 55 as measured in the second direction (Y-direction). The angle α of the unit straight section 56 is an angle between straight line G that is parallel to the second direction (Y-direction) and a side 56a of the unit straight section 56. The angle α has a negative value if the side 56a is displaced counterclockwise from straight line G and a positive value if the side 56a is displaced clockwise from straight line G. The dimension of the unit straight section 56 refers to a dimension of the unit straight section 56 measured parallel to the second direction (Y-direction).

FIG. 23 is a microscope image of a light-diffusion film that includes cylindrical lenses that in turn include the bending sections 55 arranged in pattern A. In this sample, each cylindrical lens has a width W (dimension of the cylindrical lens as measured in the direction in which the cylindrical lenses are arrayed) of 55 μm and a height (distance from the first face of the second base member to the ridge line) of 20 nm. Adjacent cylindrical lenses are separated by a distance, s, of 2 km.

FIG. 23 shows that the cylindrical lenses are bent. The ridge lines appear white in FIG. 23.

Next, the inventors evaluated optical properties of light-diffusion films that include cylindrical lenses that in turn include the bending sections 55 arranged in pattern A. The cylindrical lenses were composed of a transparent resin.

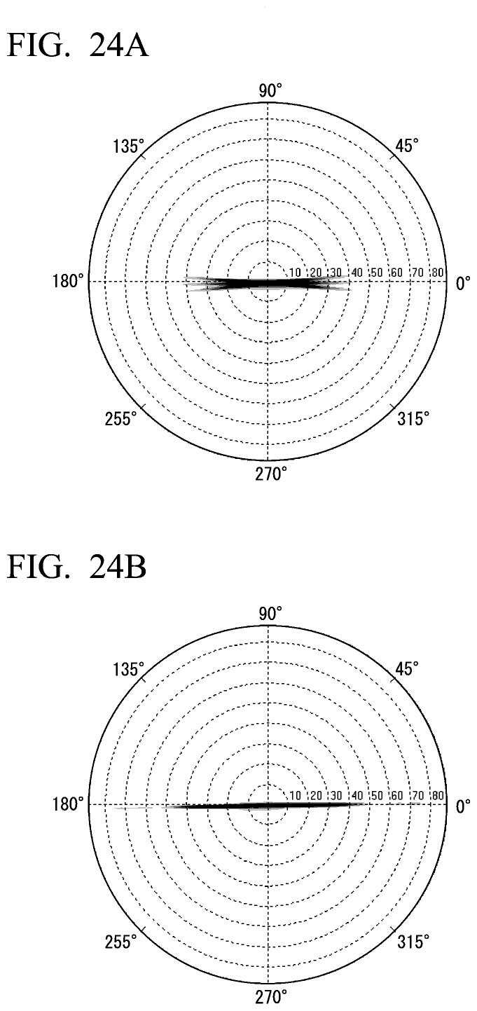

FIG. 24A is a diagram representing a luminance distribution of light exiting a light-diffusion film in accordance with an example of the invention. FIG. 24B is a diagram representing a luminance distribution of light exiting a conventional light-diffusion film (light-diffusion film that includes cylindrical lenses that include no bending sections). In FIGS. 24A and 24B, the direction denoted by azimuth 0-180° corresponds to the direction in which the cylindrical lenses are arrayed (first direction, X-direction), and the direction denoted by azimuth 90°-270° corresponds to the general direction in which the cylindrical lenses are extended (second direction, Y-direction).

The cylindrical lenses in conventional light-diffusion films are diffusive only in the direction in which the cylindrical lenses are arrayed. FIG. 24B therefore shows that outgoing light is diffused only in the direction denoted by azimuth 0°-180°.

In contrast, in the light-diffusion film of the present example of the invention, the direction denoted by azimuth 0°-180° is the inherent diffusion direction of the cylindrical lenses. FIG. 24A shows that light is diffused across a broad range of polar angle in this direction. FIG. 24A also shows that due to the provision of the bending sections in the cylindrical lenses, light is diffused strongly in the 175°-355° direction and in the 5°-185° direction as well as in the 0°-180° direction. Light coming from the front (polar angle=0°) up to polar angle=20° and then diffused in these three directions appears to be traveling, without being sufficiently separated, like a single flux of diffused light traveling in the 90°-70° direction, so far as understood from FIG. 24A.

The inventors used three types of materials for the cylindrical lenses: a transparent resin, a poorly scattering resin, and a moderately scattering resin. The inventors investigated a relationship between a polar angle and a transmittance for the light leaving the light-diffusion films, obtained for different values of azimuth.

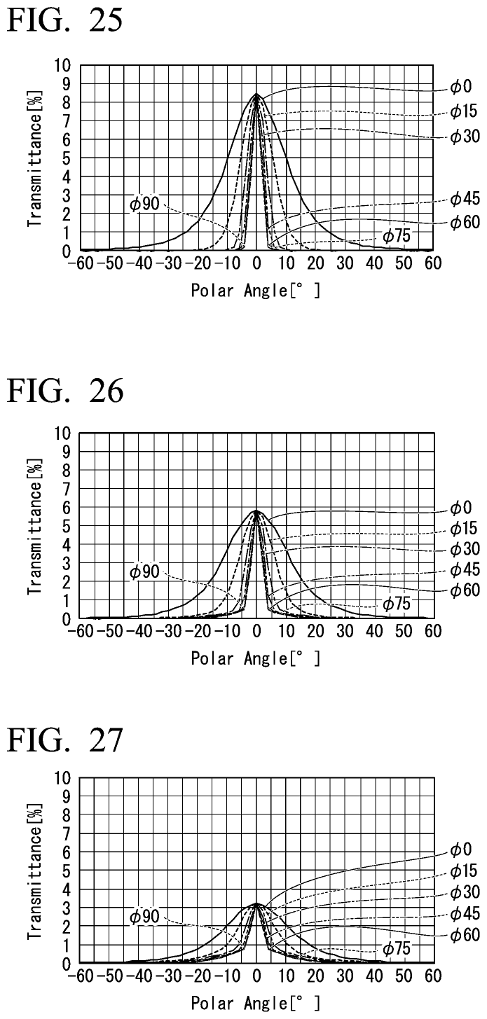

FIG. 25 is a graph representing a relationship between a polar angle and a transmittance for light exiting a light-diffusion film composed of a transparent resin, obtained for different values of azimuth. FIG. 26 is a graph representing a relationship between a polar angle and a transmittance for light exiting a light-diffusion film composed of a poorly scattering resin, obtained for different values of azimuth. FIG. 27 is a graph representing a relationship between a polar angle and a transmittance for light exiting a light-diffusion film composed of a moderately scattering resin, obtained for different values of azimuth.

In FIGS. 25 to 27, the line indicated by symbol Φ0 represents a relationship between a polar angle and a transmittance for the direction denoted by azimuth 0°-180° (direction in which the cylindrical lenses are arrayed). The line indicated by symbol Φ15 represents a relationship between a polar angle and a transmittance for the direction denoted by azimuth 15°-195°. The line indicated by symbol Φ30 represents a relationship between a polar angle and a transmittance for the direction denoted by azimuth 30°-210°. The line indicated by symbol Φ45 represents a relationship between a polar angle and a transmittance for the direction denoted by azimuth 450-225°. The line indicated by symbol Φ90 represents a relationship between a polar angle and a transmittance for the direction denoted by azimuth 90°-270° (direction in which the cylindrical lenses are extended).

FIG. 25 shows that light is diffused by the cylindrical lenses in a broad range of polar angle for azimuth 0°-180°. FIG. 25 also shows that light is diffused for azimuth 90°-270° in the present example of the invention owing to the provision of bending sections in the cylindrical lenses. FIGS. 26 and 27 show that the increased inherent scattering ability that the cylindrical lenses composed of a moderately scattering resin have over the scattering ability of the cylindrical lenses composed of a poorly scattering resin decreases the peak value of the transmittance at polar angle 0° and increases the transmittance at 5° or greater polar angles for azimuth 900-270°, thereby better diffusing light.

Next, the inventors evaluated characteristics of whole daylighting devices, which are combinations of these light-scattering films and daylighting films.

Specifically, in the daylighting device 1 shown in FIG. 1, parallel light was shone onto the daylighting film vertically from above at an angle of incidence of 35°, to obtain a chromaticity distribution of the light exiting the light-diffusion film 2. The normal to the first face 4a of the first base member 4 was designated as polar angle 0°. The direction in which the cylindrical lenses 5 are arrayed was designated as azimuth 0°-180°. The vertically upward direction was designated as azimuth 90°. The vertically downward direction was designated as azimuth 270°.

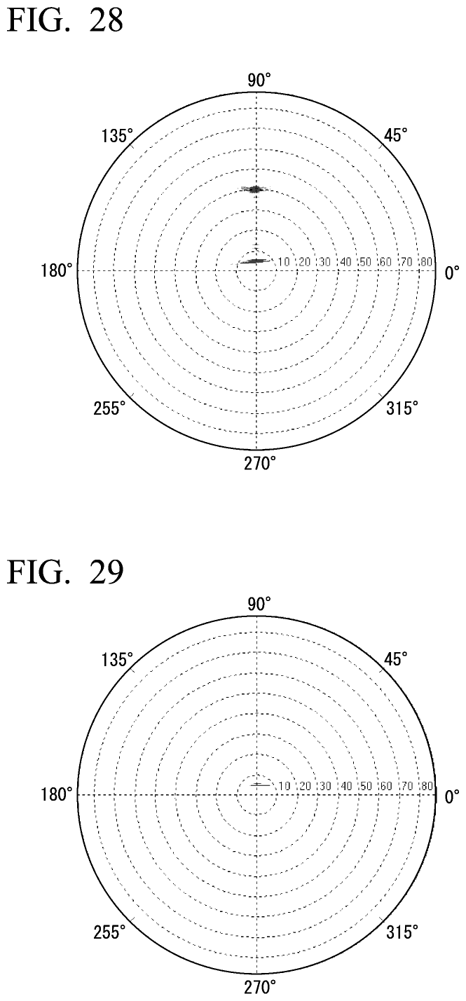

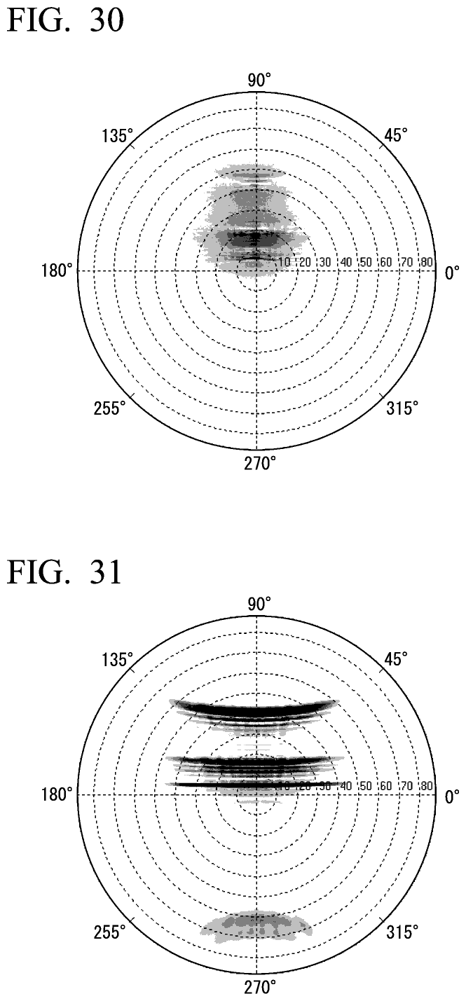

FIG. 28 is a diagram representing a chromaticity distribution C(a*b*) of light exiting a daylighting device that includes a light-diffusion film composed of a transparent resin. FIG. 29 is a diagram representing a chromaticity distribution of light exiting a daylighting device that includes a light-diffusion film composed of a poorly scattering resin. FIG. 30 is a diagram representing a chromaticity distribution of light exiting a daylighting device that includes a light-diffusion film composed of a moderately scattering resin. FIG. 31 is a diagram representing a chromaticity distribution of light exiting a conventional daylighting device. The value of C(a*b*) grows larger for angles at which exiting light is more colored as a result of color break-up.

Referring to FIG. 31, light exits the conventional daylighting device at a specific angle of emergence above the horizontal plane. Light is much diffused at azimuth 0°-180° (horizontal direction), but hardly diffused at azimuth 90°-270° (vertical direction), which evidences strong color break-up.

In contrast, FIGS. 28 to 30 show that the daylighting device in accordance with the present example of the invention has a narrower range of angle for which light is colored, and also causes less coloring than, the conventional daylighting device, thereby reducing color break-up, owing to the component diffused in azimuth 90°-270° (vertical direction) in addition to the component diffused in azimuth 0°-180° (horizontal direction). FIGS. 28 to 30 also show that color break-up is reduced progressively with increasing scattering ability of the cylindrical lenses.

Next, the inventors investigated an optimal range of the bending angle for cylindrical lenses.

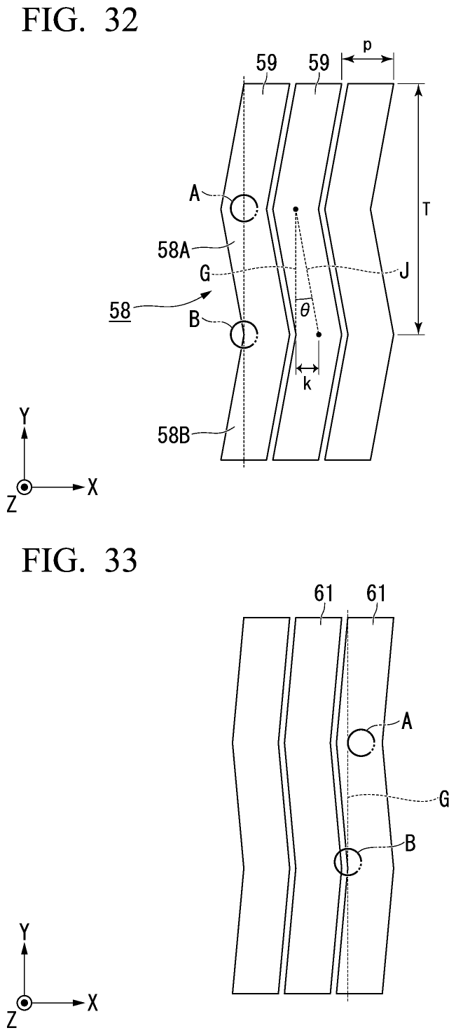

FIG. 32 is a front view showing an example shape of an optimal cylindrical lens. FIG. 33 is a front view showing a shape of a cylindrical lens in accordance with a comparative example.

In FIG. 32, T is a repeating period of a bending section 58 (length of the bending section 58 as measured in the second direction (Y-direction)), p is a pitch between adjacent cylindrical lenses 59, and θ is a bending angle of the bending section 58. For those cylindrical lenses 59 that are arrayed with different pitches, p is equal to their average pitch. In the light-diffusion film shown in FIG. 32, the bending section 58 of the cylindrical lens 59 includes a first inclined section 58A and a second inclined section 58B that are tilted oppositely with respect to the second direction (Y-direction).

In FIG. 32, bending angle θ is an angle between centerline J of the first inclined section 58A (alternatively, of the second inclined section 58B) and straight line G parallel to the second direction. The bending section can be, for instance, a combination of more straight segments as shown in, for example, FIG. 7 or FIG. 22 or a mere curved segment with no straight segments as shown in FIG. 8. Taking these cases into consideration, bending angle θ is given by mathematical expression (1) below, where k is a bending width.

θ=atan[k/(T/2)] (1)

Bending width k is, as shown in FIG. 22, the distance in the X-direction between the middle point of one of the straight sections that is positioned on the most positive end of the bending section 55 as traced along the X-direction and the middle point of another one of the straight sections that is positioned on the most negative end thereof as traced along the X-direction.

Bending angle θ is preferably set to satisfy mathematical expression (2) below.

p/2≤T/2×tan θ (2)

Letter A in FIG. 32 indicates a position where the lens surface of the cylindrical lens 59 is highest, and letter B indicates a position where the lens surface of the cylindrical lens 59 is lowest. Changes in the height of the lens surface in the second direction can be maximized by setting bending angle θ in such a manner as to satisfy mathematical expression (2).

Conversely, it is not preferable to set bending angle θ to a small value, or specifically, to set bending angle θ in such a manner as to satisfy mathematical expression (3) below, as in a cylindrical lens 61 in accordance with a comparative example shown in FIG. 33.

p/2>T/2×tan θ (3)

Letter A in FIG. 33 indicates a position where the lens surface of the cylindrical lens 59 is highest, and letter B indicates a position where the lens surface of the cylindrical lens 59 is lowest, for the following reasons. As shown in FIG. 33, straight line G parallel to the second direction does not pass through highest point A and lowest point B simultaneously in this case. That translates into smaller changes in the height of the lens surface in the second direction than when mathematical expression (2) is satisfied. Expected advantages of the present example of the invention are hence not sufficiently achieved.

If the bending sections have an excessively long repeating period T, the bending sections form mere oblique lines, and the daylighting device may appear horizontally asymmetric depending on the position from which the daylighting device is viewed. Therefore, the period needs to be equal to or shorter than the resolution of the human eye in the actual operating environment, or specifically, when the daylighting device is viewed at a distance of at least 1 meter. The cylindrical lenses preferably have a pitch p that is smaller than the thickness of the first base member.

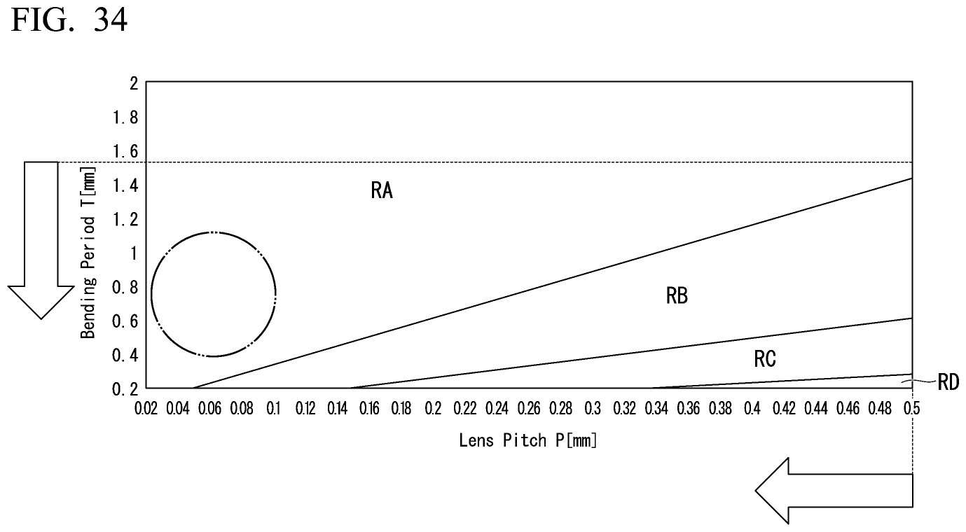

FIG. 34 is a graph representing a relationship between the pitch p of the cylindrical lenses and the repeating period T of the bending section, obtained for different bending angles of the cylindrical lenses. The graph shows the pitch p [mm] of the cylindrical lenses on the horizontal axis thereof and the repeating period T [mm] of the bending sections on the vertical axis thereof.

Of the domains divided up by three lines, it is the domain labeled RA that corresponds to a range of bending angle θ from 0° to 20°, the domain labeled RB that corresponds to a range of bending angle θ from 20° to 40°, the domain labeled RC that corresponds to a range of bending angle θ from 40° to 60°, and the domain labeled RD that corresponds to a range of bending angle θ from 60° to 80°. The light-diffusion film of the present embodiment gives no bending angle θ that falls in domains RC and RD.

The repeating period T of the bending section, when set to 1.5 mm or shorter, is shorter than or equal to the resolution of the eye of a person who has a visual acuity measurement of 20/20 and who is at a distance of at least 5 meters from the daylighting device. The light-diffusion film in accordance with the present embodiment is assumed to be so designed that its bending angle falls in the circle drawn in domain RA. A specific set of example parameters would include a pitch p of the cylindrical lenses that is set approximately to from 0.02 mm to 0.2 mm, a repeating period T of the bending section that is set approximately to from 0.5 mm to 1.5 mm, and a bending angle θ that is set approximately to from 0.8° to 22°.

### Second Embodiment

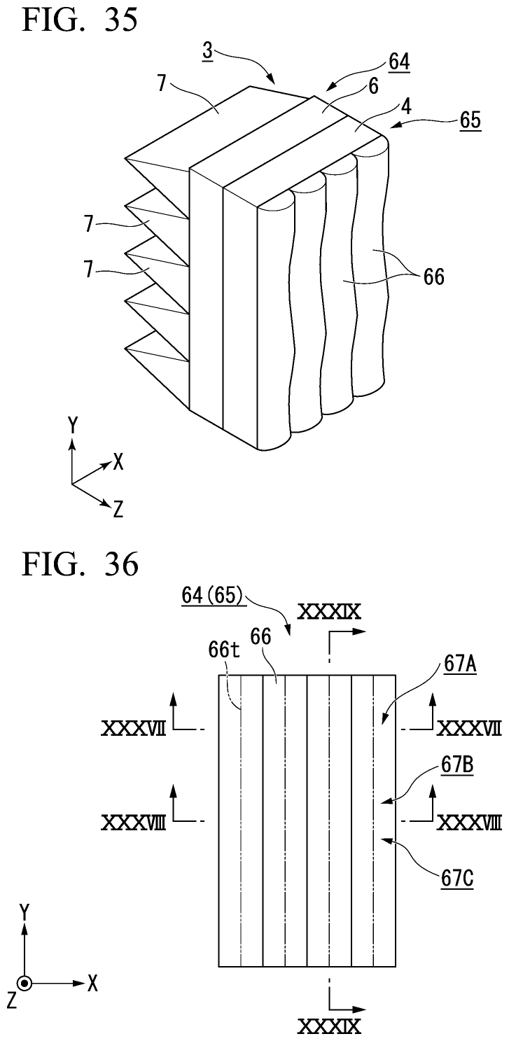

The following will describe a second embodiment of the present invention in reference to FIGS. 35 to 42.

A daylighting device in accordance with the second embodiment has the same basic structure as the daylighting device in accordance with the first embodiment and includes cylindrical lenses of a different structure than the first embodiment.

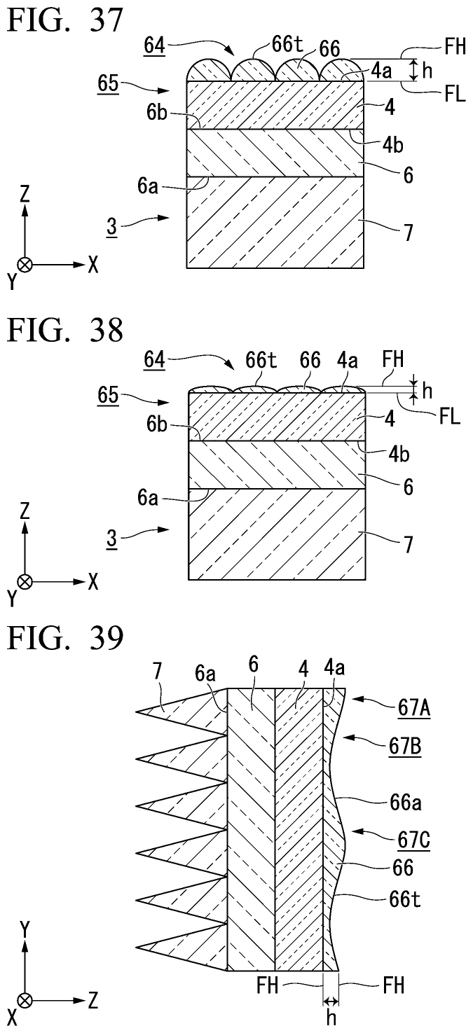

FIG. 35 is a perspective view of the daylighting device in accordance with the second embodiment. FIG. 36 is a front view of the daylighting device. FIG. 37 is a cross-sectional view of the daylighting device, taken along line XXXVII-XXXVII shown in FIG. 36. FIG. 38 is a cross-sectional view of the daylighting device, taken along line XXXVIII-XXXVIII shown in FIG. 36. FIG. 39 is a cross-sectional view of the daylighting device, taken along line XXXIX-XXXIX shown in FIG. 36.

Members shown in FIGS. 35 to 42 that also appear in the drawings used in the first embodiment are denoted by the same reference numerals, and their description is not repeated.

Referring to FIGS. 35 to 39, a daylighting device 64 in accordance with the present embodiment includes a light-diffusion film 65 (light-diffusion member) and a daylighting film 3 (daylighting member). The light-diffusion film 65 includes a first base member 4 and a plurality of cylindrical lenses 66 that is provided on a first face 4a of the first base member 4. The daylighting film 3 includes a second base member 6 and a plurality of daylighting sections 7 that is provided on a first face 6a of the second base member 6. The light-diffusion film 65 and the daylighting film 3 are attached together such that the first base member 4 has a second face 4a thereof facing a second face 6b of the second base member 6 and that the cylindrical lenses 66 are perpendicular to the daylighting sections 7. In other words, the direction in which the daylighting sections 7 are arrayed crosses the direction in which the cylindrical lenses 66 are arrayed.

In the light-diffusion film 2 in accordance with the first embodiment, the cylindrical lenses 5 include the bending sections 9, 14, or 19 or the curved sections 24. In contrast, in the light-diffusion film 65 in accordance with the second embodiment, as shown in FIG. 36, the cylindrical lenses 66 include no bending sections and no curved sections and are extended linearly in a direction substantially parallel to the second direction (Y-direction) when viewed normal to the first face 4a of the first base member 4 (Z-direction). In other words, the cylindrical lenses 66 have ridge lines 66t extended linearly in a direction substantially parallel to the second direction (Y-direction).

Each cylindrical lens 66 is, unlike in the first embodiment, extended linearly when viewed in the Z-direction as described here. The cylindrical lens 66 has a lens surface 66a with a height that continuously changes with a prescribed period, as shown in FIG. 39, when viewed in a cross-section (that is perpendicular to the X-direction) of the cylindrical lens 66 taken along a second imaginary plane (plane of the paper) that is both parallel to the second direction (Y-direction) and perpendicular to a first imaginary plane (XY-plane) containing both the first direction (X-direction) and the second direction (Y-direction).

In the second embodiment, similarly to the first embodiment, calling the lowest place between adjacent cylindrical lenses 66 a groove, an imaginary plane that contains such grooves and that is parallel to the XY-plane will be designated as a bottom face FL of the cylindrical lenses 66, and an imaginary plane that contains the ridge lines 66t and that is parallel to the XY-plane will be designated as a top face FH of the cylindrical lenses 66, as shown in FIGS. 37 to 39. The dimension in the Z-direction from the bottom face FL to the top face FH is designated as the height h of the lens surface 66a of the cylindrical lens 66.

The cylindrical lens 66 includes: a fixed-height section 67A where the lens surface 66a has a substantially constant height; a first inclined section 67B where the lens surface 66a has a height that gradually decreases starting at the height that the lens surface 66a has in the fixed-height section 67A; and a second inclined section 67C where the lens surface 66a has a height that gradually increases up to the height that the lens surface 66a has in the fixed-height section 67A. A combination of the fixed-height section 67A, the first inclined section 67B, and the second inclined section 67C is repeated. The height of the lens surface 66a changes with a particular period.

The cylindrical lens 66, in a cross-section thereof taken perpendicular to the direction in which the cylindrical lens 66 is extended (in a cross-section thereof taken perpendicular to the Y-direction), has a relatively high arc (small radius of curvature) in the fixed-height section 67A as shown in FIG. 37 and a relatively low arc (large radius of curvature) at the boundary of the first inclined section 67B and the second inclined section 67C (in the groove) as shown in FIG. 38.

The light-diffusion film 65 otherwise has the same structure as in the first embodiment. The daylighting film 3 has the same structure as in the first embodiment.

The present embodiment can, similarly to the first embodiment, achieve an advantage that the light dispersed by the daylighting sections is mingled by the cylindrical lenses 66 to produce whitish light.

The daylighting device 64 in accordance with the present embodiment may be modified as in the diverse variation examples detailed below.

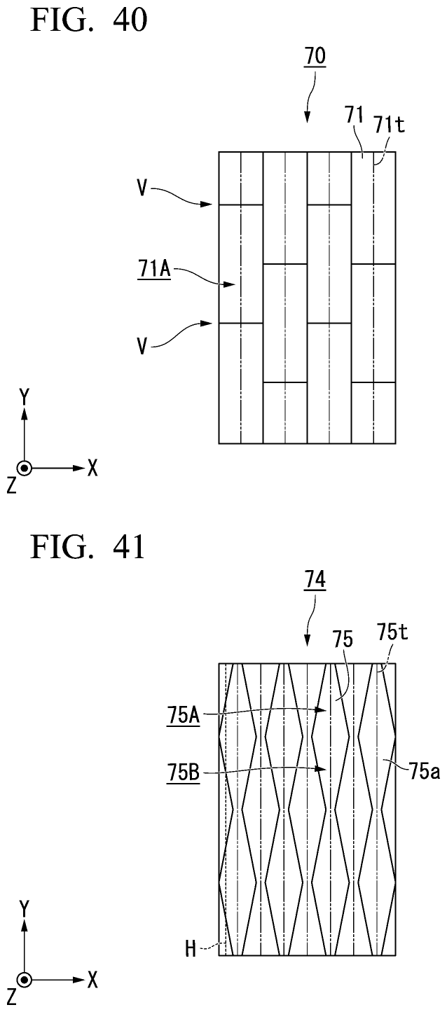

FIG. 40 is a cross-sectional view of a light-diffusion film 70 in accordance with a first variation example.

The cylindrical lens is not necessarily continuous in the direction in which the cylindrical lens is extended. Referring to FIG. 40, the light-diffusion film 70 in accordance with the first variation example includes a cylindrical lens 71 that is generally disposed linearly, but discontinuous at sites V. Therefore, the cylindrical lens 71 has a zero height at the sites V where the cylindrical lens 71 is discontinuous. The cylindrical lens 71 has a lens surface 71a with a ridge line 71t whose height gradually decreases from a fixed-height section 71A toward the sites V where the cylindrical lens 71 is discontinuous.

FIG. 41 is a cross-sectional view of a light-diffusion film 74 in accordance with a second variation example.

The cylindrical lens does not necessarily have a constant width (dimension as measured perpendicular to the direction in which the cylindrical lens is extended) anywhere along the direction in which the cylindrical lens is extended. Referring to FIG. 41, the light-diffusion film 74 in accordance with the second variation example includes a cylindrical lens 75 in which there are alternately and repeatedly provided: a section 75A where the cylindrical lens 75 has a width that gradually increases from an end thereof toward the other end thereof in terms of the direction in which the cylindrical lens 75 is extended; and a section 75B where the cylindrical lens 75 has a width that gradually decreases from an end thereof toward the other end thereof in terms of the direction in which the cylindrical lens 75 is extended. The cylindrical lens 75 has a lens surface 75a with a ridge line 75t that is extended linearly in the direction in which the cylindrical lens 75 is extended. The width of the cylindrical lens 75 changes linearly in the section 75A and the section 75B.

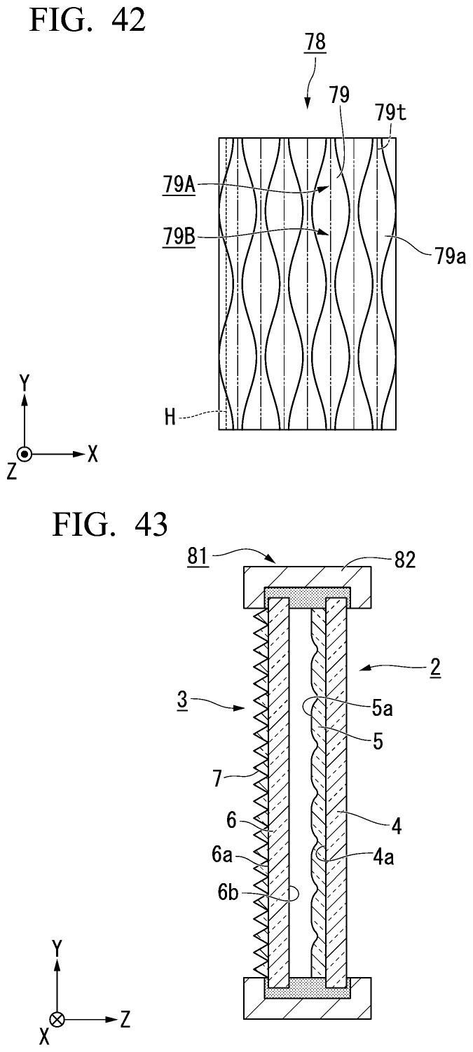

FIG. 42 is a cross-sectional view of a light-diffusion film 78 in accordance with a third variation example.

Referring to FIG. 42, similarly to the light-diffusion film 74 in accordance with the second variation example, the light-diffusion film 78 in accordance with the third variation example includes a cylindrical lens 79 in which there are alternately and repeatedly provided: a section 79A where the cylindrical lens 79 has a width that gradually increases from an end thereof toward the other end thereof in terms of the direction in which the cylindrical lens 79 is extended; and a section 79B where the cylindrical lens 79 has a width that gradually decreases from an end thereof toward the other end thereof in terms of the direction in which the cylindrical lens 79 is extended. The cylindrical lens 79 has a lens surface 79a with a ridge line 79t that is extended linearly in the direction in which the cylindrical lens 79 is extended. The width of the cylindrical lens 79 changes non-linearly in the section 79A and the section 79B.

The light-diffusion films 74 and 78 in accordance with the second and third variation examples have a continuously changing cross-section that is taken along the ridge lines 75t and 79t of the cylindrical lenses 75 and 79. The cylindrical lenses 75 and 79 have an increased height in sections thereof where the cylindrical lenses 75 and 79 have an increased width and a decreased height in sections thereof where the cylindrical lenses 75 and 79 have a decreased width. In some locations where two adjacent cylindrical lenses 75 and 79 have an increased width, the cylindrical lens 75 and 79 interposed between these two adjacent cylindrical lenses 75 and 79 has a decreased width. In other words, in some locations where adjacent cylindrical lenses 75 and 79 have different widths, these cylindrical lenses 75 and 79 have ridge lines with different heights. Owing these particulars, the light-diffusion films 74 and 78 in accordance with these variation examples can achieve the same advantages as in the previous embodiment.

### Third Embodiment

The following will describe a third embodiment of the present invention in reference to FIGS. 43 to 46.

A daylighting device in accordance with the third embodiment has a basic structure that, unlike in the first embodiment, includes a daylighting member and a light-diffusion member as separate members.

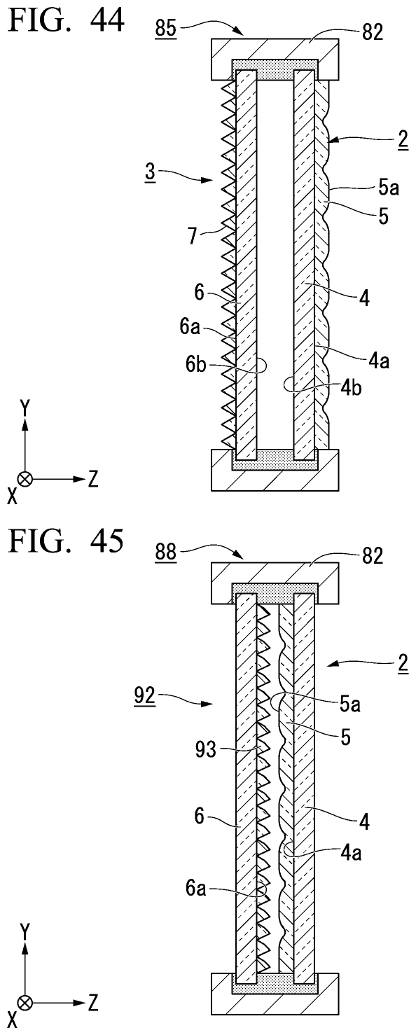

FIG. 43 is a perspective view of the daylighting device in accordance with the third embodiment. FIG. 44 is a perspective view of a daylighting device in accordance with a first variation example of the third embodiment. FIG. 45 is a perspective view of a daylighting device in accordance with a second variation example of the third embodiment. FIG. 46 is a perspective view of a daylighting device in accordance with a third variation example of the third embodiment.

Members shown in FIGS. 43 to 46 that also appear in the drawings used in the first embodiment are denoted by the same reference numerals, and their description is not repeated.

Referring to FIG. 43, a daylighting device 81 in accordance with the third embodiment includes a daylighting film 3, a light-diffusion film 2, and a frame 82. The daylighting film 3 includes a second base member 6 and a plurality of daylighting sections 7 that is provided on a first face 6a of the second base member 6. The light-diffusion film 2 includes a first base member 4 and a plurality of cylindrical lenses 5 that is provided on a first face 4a of the first base member 4. The daylighting film 3 and the light-diffusion film 2 are separated by a prescribed distance from each other and housed inside the frame 82. The daylighting device 81 is installed hanging down, for example, from a supporting member over a window pane that faces the interior of the room.

The direction in which the daylighting sections 7 of the daylighting film 3 are extended and the direction in which the cylindrical lenses 5 of the light-diffusion film 2 are extended are approximately perpendicular to each other when viewed perpendicular to the first face 4a of the first base member 4. The daylighting film 3 and the light-diffusion film 2 are, in the present embodiment, arranged such that the second face 6b of the second base member 6 (the face on which there are provided no daylighting sections 7) is opposite the first face 4a of the first base member 4 (the face on which there are provided the cylindrical lenses 5). In other words, the daylighting film 3 is disposed such that the daylighting sections 7 face outdoors, and the light-diffusion film 2 is disposed such that the cylindrical lenses 5 face outdoors.

The light-diffusion film 2 in accordance with the present embodiment has the same structure as the light-diffusion film in accordance with the first embodiment or the second embodiment. In other words, the height of the lens surface 5a above the first face 4a continuously changes when viewed in a cross-section of the cylindrical lens 7 taken perpendicular to the first face 4a of the first base member 4 and parallel to the direction in which the cylindrical lens 5 is extended (second direction).

The present embodiment can, similarly to the first embodiment, achieve an advantage that the light dispersed by the daylighting sections 7 is mingled by the cylindrical lenses 5 to produce whitish light.

Since the daylighting film 3 and the light-diffusion film 2 are provided as separate members in the daylighting device 81 in accordance with the present embodiment, it is easy to replace either film when the film is, for example, scratched or otherwise damaged.

The daylighting device 81 in accordance with the present embodiment may be modified as in the diverse variation examples detailed below.

FIG. 44 is a cross-sectional view of a daylighting device 85 in accordance with the first variation example.

Referring to FIG. 44, the daylighting film 3 and the light-diffusion film 2 are, in the daylighting device 85 in accordance with the first variation example, arranged such that the second face 6b of the second base member 6 (the face on which there are provided no daylighting sections 7) is opposite a second face 4b of the first base member 4 (the face on which there are provided no cylindrical lenses 5). In other words, the daylighting film 3 is disposed such that the daylighting sections 7 face outdoors, and the light-diffusion film 2 is disposed such that the cylindrical lenses 5 face indoors.

FIG. 45 is a cross-sectional view of a daylighting device 88 in accordance with the second variation example. Referring to FIG. 45, a daylighting film 92 and the light-diffusion film 2 are, in the daylighting device 88 in accordance with the second variation example, arranged such that the first face 6a of the second base member 6 (the face on which there are provided a plurality of daylighting sections 93) is opposite the first face 4a of the first base member 4 (the face on which there are provided the cylindrical lenses 5). In other words, the daylighting film 92 is disposed such that the daylighting sections 93 face indoors, and the light-diffusion film 2 is disposed such that the cylindrical lenses 5 face outdoors.

FIG. 46 is a cross-sectional view of a daylighting device 91 in accordance with the third variation example.

Referring to FIG. 46, a daylighting film 92 and the light-diffusion film 2 are, in the daylighting device 91 in accordance with the third variation example, arranged such that the first face 6a of the second base member 6 (the face on which there are provided the daylighting sections 93) is opposite the second face 4b of the first base member 4 (the face on which there are provided no cylindrical lenses 5). In other words, the daylighting film 92 is disposed such that the daylighting sections 93 face indoors, and the light-diffusion film 2 is disposed such that the cylindrical lenses 5 face indoors.

When the daylighting sections 7 face outdoors as is the case with the daylighting devices 81 and 85 in accordance with the third embodiment and the first variation example thereof respectively, the daylighting sections may have, for example, the triangular cross-section shown in FIG. 1 or the pentagonal cross-section shown in FIG. 17. Meanwhile, when the daylighting sections 93 face indoors as is the case with the daylighting devices 88 and 91 in accordance with the second variation example and the third variation example respectively, the daylighting sections may have, for example, the quadrilateral cross-section shown in FIGS. 45 and 46.

### Fourth Embodiment

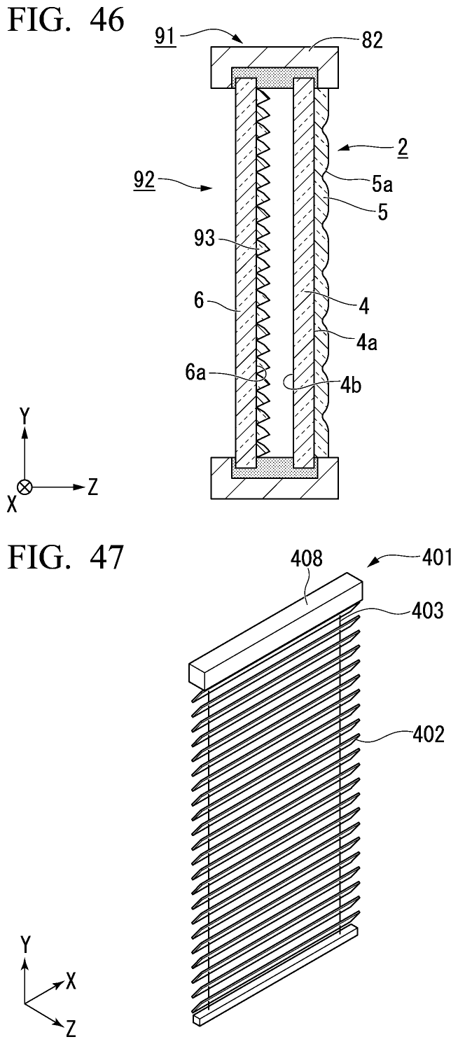

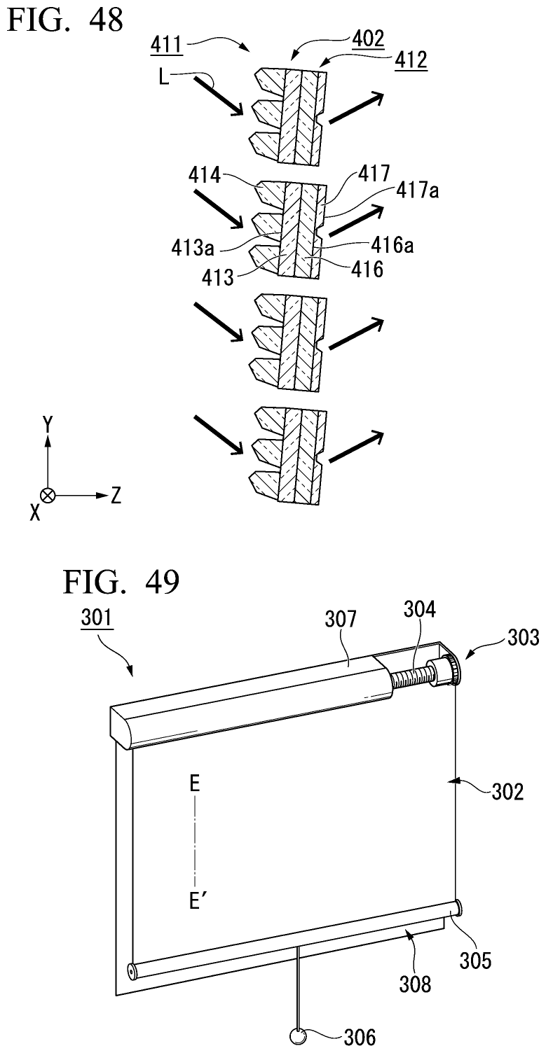

The following will describe a fourth embodiment of the present invention in reference to FIGS. 47 and 48.

A daylighting device in accordance with the fourth embodiment has a basic structure that, unlike in the first embodiment, includes, as an example, a daylighting window shade as a daylighting device.

FIG. 47 is a perspective view of a daylighting device in accordance with the fourth embodiment. FIG. 48 is a cross-sectional view of the daylighting device.

Members shown in FIGS. 47 and 48 that also appear in the drawings used in the first embodiment are denoted by the same reference numerals, and their description is not repeated.

Referring to FIG. 31, a daylighting window shade 401 includes: a plurality of daylighting slats 402 arranged above one another at prescribed intervals; a tilt mechanism (supporting mechanism) 403 that supports the daylighting slats 402 in a freely tiltable manner; and a storage mechanism 408 that folds up and houses the daylighting slats 402 connected by the tilt mechanism 403 in such a manner that the daylighting slats 402 can be taken out and stored away.

Referring to FIG. 48, each daylighting slat 402 includes a daylighting plate 411 and a light-diffusion plate 412 attached together. The daylighting plate 411 includes a second base member 413 and a plurality of daylighting sections 414 that is provided on a first face 413a of the second base member 413. The light-diffusion plate 412 includes a first base member 416 and a plurality of cylindrical lenses 417 that is provided on a first face 416a of the first base member 416. The height of a lens surface 417a above the first face 416a continuously changes when viewed in a cross-section of the cylindrical lens 417 taken perpendicular to the first face 416a of the first base member 416 and parallel to the direction in which the cylindrical lens 417 is extended (second direction). The cylindrical lenses 417 may have the same structure as any of the structures described as examples in the first and second embodiments. As another alternative, the first base member 416 and the second base member 413 may be provided as a single, common base member so that there are provided the daylighting sections 414 and the cylindrical lenses 417 on the respective sides of the single base member to form a daylighting slat.

The tilt mechanism 403 includes a plurality of ladder cords (not shown) that is extended along the length of the daylighting slats 402 to support the daylighting slats 402. The tilt mechanism 403 includes an operation mechanism (not shown) for vertically moving two vertical cords for the ladder cords in opposite directions. Using the tilt mechanism 403, the daylighting slats 402 can be tilted in synchronism with each other by moving the vertical cords by means of the operation mechanism.

The daylighting window shade 401 is suspended from a ceiling on the indoor side of a window pane (not shown) and used facing the interior side of the window pane. The daylighting slats 402 are arranged such that the direction in which the daylighting sections 414 are arrayed matches the heightwise direction of the window pane (vertical direction).

In other words, the daylighting slats 402 are arranged such that the direction in which the daylighting sections 414 are extended over the window pane matches the widthwise direction of the window pane (horizontal direction).

The daylighting device is installed with the daylighting sections 414 facing outdoors and the cylindrical lenses 417 facing indoors, so that the daylighting slats 402 can guide light into the room.

Referring to FIG. 48, light L having passed through the window pane and entered the inside of the room changes its traveling direction due to the daylighting sections 414 of the daylighting window shade 401 facing the indoor side of the window pane, thereby exiting the daylighting sections 414 in the direction of the ceiling of the room. Upon hitting the ceiling, light L is reflected by the ceiling and illuminates the inside of the room, which may fill the need for artificial lighting. Therefore, the use of such a daylighting window shade 401 may advantageously make savings on energy consumption of the building's lighting equipment during the daytime.

The present embodiment can, similarly to the first embodiment, achieve an advantage that the light dispersed by the daylighting sections 414 is mingled by the cylindrical lenses 417 to produce whitish light.

In addition, the daylighting window shade 401 enables the angle of light L traveling in the direction of the ceiling to be adjusted by tilting the daylighting slats 402. The daylighting window shade 401 also enables the quantity of light entering the room through the gaps between the daylighting slats 402 to be adjusted by tilting the daylighting slats 402.

As described in the foregoing, by using the daylighting window shade 401 in accordance with the present embodiment, outdoor natural light (sunlight) can be efficiently guided indoors so as to brightly light up deep into the room without letting the room's occupants be dazzled by glare.

### Fifth Embodiment

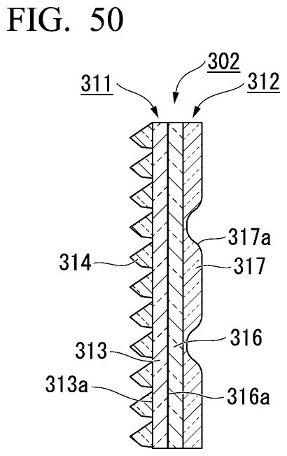

The following will describe a fifth embodiment of the present invention in reference to FIGS. 49 and 50.

A daylighting device in accordance with the fifth embodiment has a basic structure that, unlike in the first embodiment, includes, as an example, a daylighting roll screen as a daylighting device.

FIG. 49 is a perspective view of the daylighting device in accordance with the fifth embodiment. FIG. 50 is a cross-sectional view of the daylighting device.

Members shown in FIGS. 49 and 50 that also appear in the drawings used in the first embodiment are denoted by the same reference numerals, and their description is not repeated.

Referring to FIG. 49, a daylighting roll screen 301 includes a daylighting screen 302 and a winding mechanism 303 that supports the daylighting screen 302 in a freely windable manner.

Referring to FIG. 50, the daylighting screen 302 includes a daylighting film 311 and a light-diffusion film 312 attached together. The daylighting film 311 includes a second base member 313 and a plurality of daylighting sections 314 that is provided on a first face 313a of the second base member 313. The light-diffusion film 312 includes a first base member 316 and a plurality of cylindrical lenses 317 that is provided on a first face 316a of the first base member 316. The height of a lens surface 317a above the first face 316a continuously changes when viewed in a cross-section of the cylindrical lens 317 taken perpendicular to the first face 316a of the first base member 316 and parallel to the direction in which the cylindrical lens 317 is extended (second direction). The cylindrical lenses 317 may have the same structure as any of the structures described as examples in the first and second embodiments. As another alternative, the first base member 316 and the second base member 313 may be provided as a single, common base member so that there are provided the daylighting sections 314 and the cylindrical lenses 317 on the respective sides of the single base member to form a daylighting screen.

Referring to FIG. 49, the winding mechanism 303 includes: a winding core (supporting member) 304 attached along the upper end of the daylighting screen 302; a bottom pipe (supporting member) 305 attached along the lower end of the daylighting screen 302; a pull string 306 attached to the middle of the lower end of the daylighting screen 302; and a storage enclosure 307 that houses the daylighting screen 302 wound around the winding core 304.

The winding mechanism 303, which is of a pull-string type, is capable of locking the daylighting screen 302 anywhere as it is being pulled out and also capable of, when the pull string 306 is pulled further down, unlocking and allowing the daylighting screen 302 to be automatically wound around the winding core 304. The winding mechanism 303 is not necessarily of a pull-string type and may alternatively be, for example, of a chain type in which the winding core 304 is rotated using a chain or of an automatic type in which the winding core 304 is rotated using an electric motor.

The daylighting roll screen 301, structured as described above, is used with the storage enclosure 307 being secured to the top of the window pane 308 in such a manner that the daylighting screen 302 can be pulled out of the storage enclosure 307 over the indoor side of a window pane 308 by means of the pull string 306. The daylighting screen 302 is installed over the window pane 308 such that the direction in which a plurality of daylighting sections 3 is arrayed matches the heightwise direction of the window pane 308 (vertical direction). In other words, the daylighting screen 302 is installed over the window pane 308 such that the length of the daylighting sections 314 matches the widthwise direction of the window pane 308 (horizontal direction). The daylighting screen 301 is installed with the daylighting sections 314 facing outdoors and the cylindrical lenses 317 facing indoors.

The light having passed through the window pane 308 and entered the inside of the room changes its traveling direction due to the daylighting sections 3 of the daylighting screen 302 facing the indoor side of the window pane 308, thereby exiting the daylighting screen 302 in the direction of the ceiling of the room. Upon hitting the ceiling, the light is reflected by the ceiling and illuminates the inside of the room, which may fill the need for artificial lighting. Therefore, the use of such a daylighting roll screen 301 may advantageously make savings on energy consumption of the building's lighting equipment during the daytime.

The present embodiment can, similarly to the first embodiment, achieve an advantage that the light dispersed by the daylighting sections 314 is mingled by the cylindrical lenses 317 to produce whitish light.

As described in the foregoing, by using the daylighting roll screen 301 in accordance with the present embodiment, outdoor natural light (sunlight) can be efficiently guided indoors so as to brightly light up deep into the room without letting the room's occupants be dazzled by glare.

### Illumination System

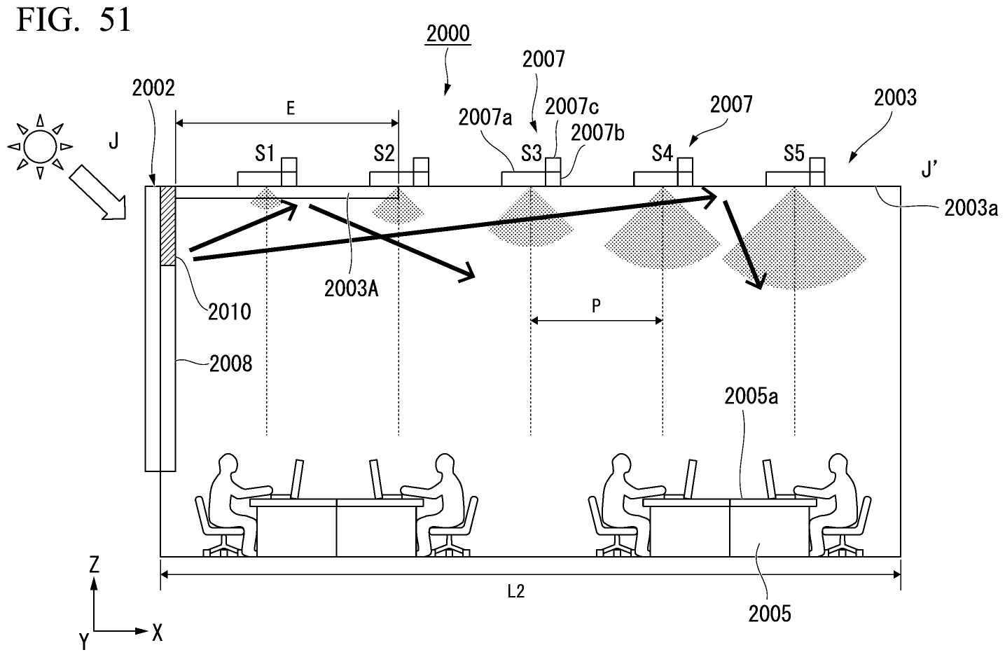

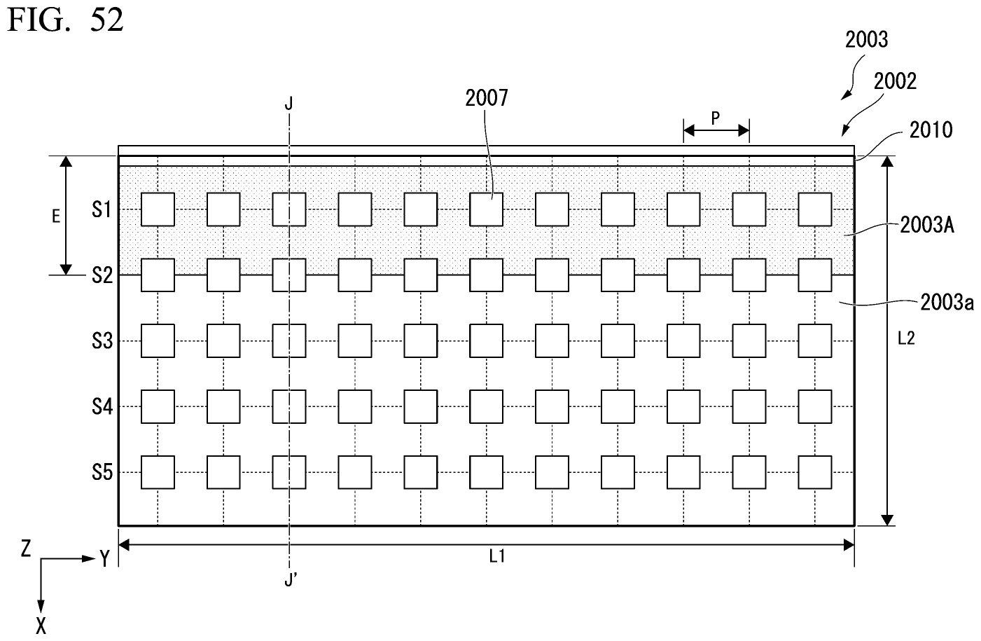

FIG. 51 is a cross-sectional view, taken along line J-J′ in FIG. 52, of a room model 2000 in which a daylighting system 2010 is installed.

FIG. 52 is a plan view of a ceiling of the room model 2000.

A room 2003 into which sunlight is guided has a ceiling 2003a constituted at least partly by a ceiling material that preferably has strong light-reflecting properties. Referring to FIGS. 51 and 52, the ceiling 2003a of the room 2003 is provided with a light-reflecting ceiling material 2003A as a ceiling material having such light-reflecting properties. The light-reflecting ceiling material 2003A is for facilitating the guiding of outdoor light from the daylighting system 2010 installed over a window 2002 deep into the interior of the room 2003. The light-reflecting ceiling material 2003A is disposed on a part of the ceiling 2003a close to the window 2002, specifically, on a predetermined part E of the ceiling 2003a (approximately up to 3 meters from the window 2002).

The light-reflecting ceiling material 2003A, as described above, serves to efficiently direct deep into the interior the sunlight guided indoors through the window 2002 over which the daylighting system 2010 including any of the daylighting devices of the abovementioned embodiments is installed. The sunlight guided in the direction of the indoor ceiling 2003a by the daylighting system 2010 is reflected by the light-reflecting ceiling material 2003A, hence changing direction and illuminating a desk top face 2005a of a desk 2005 located deep in the interior. Thus, the light-reflecting ceiling material 2003A has the advantage of lighting up the desk top face 2005a.

The light-reflecting ceiling material 2003A may be either diffuse reflective or specular reflective. Preferably, the light-reflecting ceiling material 2003A has a suitable mix of these properties to achieve both the advantage of lighting up the desk top face 2005a of the desk 2005 located deep in the interior and the advantage of reducing glare which is uncomfortable to the room's occupants.

Much of the light guided indoors by the daylighting system 2010 travels in the direction of the ceiling. The part of the interior close to the window 2002 often has sufficient lighting. Therefore, the light that strikes the ceiling near the window (part E) can be partially diverted to a deep part of the interior where lighting is poor compared to the part near the window, by using a combination of the daylighting system and the light-reflecting ceiling material 2003A.

The light-reflecting ceiling material 2003A may be manufactured, for example, by embossing convexities and concavities each of approximately a few tens of micrometers on an aluminum or similar metal plate or by vapor-depositing a thin film of aluminum or a similar metal on the surface of a resin substrate having such convexities and concavities formed thereon. Alternatively, the embossed convexities and concavities may be formed to have a curved surface with a longer period.

Furthermore, the embossed shape formed on the light-reflecting ceiling material 2003A may be changed as appropriate to control light distribution properties thereof and hence resultant indoor light distribution. For example, if stripes extending deep into the interior are embossed, the light reflected by the light-reflecting ceiling material 2003A is spread to the left and right of the window 2002 (in the directions that intersect the lengthwise direction of the convexities and concavities). When the window 2002 is limited in size or orientation, these properties of the light-reflecting ceiling material 2003A may be exploited to diffuse light in the horizontal direction and at the same time to reflect the light deep into the room.

The daylighting system 2010 is used as a part of an illumination system for the room 2003. The illumination system includes, for example, the daylighting system 2010, a plurality of room lighting devices 2007, a control system for these devices, the light-reflecting ceiling material 2003A installed on the ceiling 2003a, and all the other structural members of the room.

The window 2002 of the room 2003 has the daylighting system 2010 installed over an upper portion thereof and a shading section 2008 installed over a lower portion thereof.

In the room 2003, the room lighting devices 2007 are arranged in a lattice in the left/right direction of the window 2002 (Y-direction) and in the depth direction of the room (X-direction). These room lighting devices 2007, in combination with the daylighting system 2010, constitute an illumination system for the whole room 2003.

Referring to FIGS. 51 and 52 illustrating the office ceiling 2003a, for example, the room 2003 has a length L₁ of 18 meters in width (the left/right direction of the window 2002, Y-direction), and the room 2003 has a length L₂ of 9 meters in the depth direction (X-direction). The room lighting devices 2007 in this example are arranged in a lattice with pitches P each of 1.8 meters in the length and depth of the ceiling 2003a (Y- and X-directions). More specifically, a total of 50 room lighting devices 2007 is arranged in a lattice of 10 rows (Y-direction) and 5 columns (X-direction).

Each room lighting device 2007 includes an interior lighting fixture 2007a, a brightness detection unit 2007b, and a control unit 2007c. The brightness detection unit 2007b and the control unit 2007c are integrated into the interior lighting fixture 2007a to form the room lighting device 2007.

Each room lighting device 2007 may include two or more interior lighting fixtures 2007a and two or more brightness detection units 2007b, with one brightness detection unit 2007b for each interior lighting fixture 2007a. The brightness detection unit 2007b receives reflection off the face illuminated by the interior lighting fixture 2007a to detect illumninance on that face. In this example, the brightness detection unit 200b detects illuminance on the desk top face 2005a of the desk 2005 located indoors.

The control units 2007c, each for a different one of the room lighting devices 2007, are connected to each other. In each room lighting device 2007, the control unit 2007c, connected to the other control units 2007c, performs feedback control to adjust the light output of an LED lamp in the interior lighting fixture 2007a such that the illuminance on the desk top face 2005a detected by the brightness detection unit 2007b is equal to a predetermined target illuminance L0 (e.g., average illuminance: 750 lx).

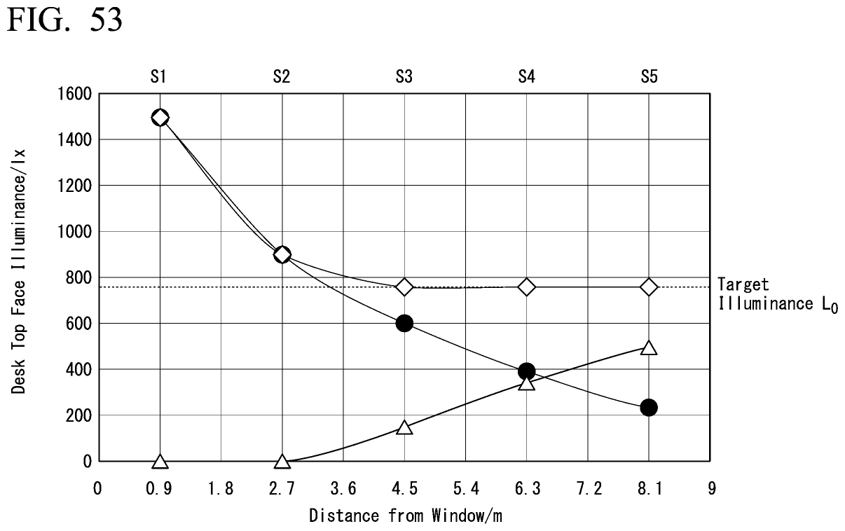

FIG. 53 is a graph representing a relationship between the illuminance produced by the daylighting light (natural light) guided into the interior by the daylighting device and the illuminance produced by the room lighting devices (illumination system). In FIG. 53, the vertical axis indicates illuminance (lx) on the desk top face, and the horizontal axis indicates distance (meters) from the window. The broken line in the figure represents a target indoor illuminance. Each black circle denotes an illuminance produced by the daylighting device, each white triangle denotes an illuminance produced by the room lighting devices, and each white diamond denotes a total illuminance.

Referring to FIG. 53, the desk top face illuminance attributable to the daylighting light guided by the daylighting system 2010 is highest at the window, and the daylighting light's effect decreases with increasing distance from the window. This illuminance distribution in the depth direction of the room is caused during the daytime by natural daylight coming through a window into the room in which the daylighting system 2010 is installed. Accordingly, the daylighting system 2010 is used in combination with the room lighting devices 2007 which enhance the indoor illuminance distribution.

The room lighting devices 2007, disposed on the indoor ceiling, detect an average illuminance below them by means of the brightness detection units 2007b and light up in a modulated manner such that the desk top face illuminance levels across the whole room are equal to the predetermined target illuminance L0. Therefore, columns S1 and S2 are near the window and only dimly light up, whereas columns S3, S4, and S5 light up so as to produce an output that increases with increasing depth into the room. Consequently, the desk top faces across the whole room are lit up by the sum of the illumination by natural daylight and the illumination by the room lighting devices 2007 at a desk top face illuminance of 750 lx, which is regarded as being sufficient for desk work across the whole room (see JIS Z9110, General Rules on Lighting, Recommended Illuminance in Offices).

As described above, light can be delivered deep into the room by using both the daylighting system 2010 and the illumination system (room lighting devices 2007) together. This can in turn further improve indoor brightness and ensure a sufficient desk top face illuminance for desk work across the whole room, hence providing a more stable, brightly lit environment independently from the season and the weather.

The technical scope of the present invention is by no means limited to the embodiments and examples described above. The invention may be altered in various manners within its spirit.

For example, the number, shape, dimensions, layout, composition, and other like specifics of each member of the daylighting device may be altered and are not necessarily limited to what is given as an example in the embodiments.

The light-diffusion films of the embodiments may be used in combination with a daylighting film that includes no daylighting sections as well as with a daylighting film that includes a plurality of daylighting sections. Furthermore, the light-diffusion films of the embodiments may be used in other applications where dispersed light needs to be converted to white light.

### INDUSTRIAL APPLICABILITY

The present invention, in an aspect thereof, is applicable to daylighting devices for guiding indoors sunlight and other outdoor light and to light-diffusion members used in these daylighting devices.

### REFERENCE SIGNS LIST

1, 12, 17, 22, 29A, 29B, 29C, 29D, 29E, 29F, 29G, 29H, 33, 37, 64, 81, 85, 88, 91 Daylighting Device
2, 65, 70, 74, 78, 312 Light-diffusion Film (Light-diffusion Member)
3, 92, 311 Daylighting Film (Daylighting Member)
4, 316, 416 First Base Member
5, 13, 18, 23, 30A, 30B, 30C, 30D1, 30E1, 30E2, 30E3, 34, 59, 61, 66, 71, 75, 79, 317, 417 Cylindrical Lens
6, 313, 413 Second Base Member
7, 38, 93, 314, 414 Daylighting Section
9, 14, 19, 55, 58 Bending Section
24 Curved Section
301 Daylighting Roll Screen (Daylighting Device)
401 Daylighting Window Shade (Daylighting Device)
411 Daylighting Plate (Daylighting Member)
412 Light-diffusion Plate (Light-diffusion Member)

1. A light-diffusion member comprising a plurality of cylindrical lenses arrayed in a prescribed direction, wherein
the cylindrical lenses are arrayed in a first direction and extended in a second direction that is perpendicular to the first direction,
the cylindrical lenses each have a curved lens surface, and
the lens surface has a height that continuously changes with a prescribed period in a cross-section of the cylindrical lens taken along a second imaginary plane that is perpendicular to a first imaginary plane containing both the first direction and the second direction and that is parallel to the second direction.

2. The light-diffusion member according to claim 1, further comprising a first base member transparent to visible light, wherein the cylindrical lenses are provided on a first face of the first base member.

3. The light-diffusion member according to claim 1, wherein
the height of the lens surface is substantially constant across the cylindrical lens, and
the cylindrical lens has a ridge line that is at least partly curved or bent when viewed normal to the first imaginary plane.

4. The light-diffusion member according to claim 3, wherein the cylindrical lenses each have in a curved or bending section thereof an inclined section tilted with respect to the second direction, the second direction forming an angle of less than 45° with a direction in which the inclined section is extended.

5. The light-diffusion member according to claim 1, wherein when viewed normal to the first imaginary plane,
the cylindrical lenses each have a ridge line linearly extended generally parallel to the second direction, and
the height of the lens surface continuously changes with a prescribed period along the ridge line.

6. The light-diffusion member according to claim 1, wherein the cylindrical lenses have a variable array period.

7. The light-diffusion member according to claim 1, wherein the cylindrical lenses each include a light-scattering member therein.

8. The light-diffusion member according to claim 1, wherein the cylindrical lenses each include a light-scattering structure on the lens surface thereof.

9. A daylighting device comprising:
a daylighting member including: a second base member transparent to visible light; and a plurality of daylighting sections transparent to visible light provided on a first face of the second base member; and
the light-diffusion member according to claim 1 provided on a light-emitting side of the daylighting member.

10. A daylighting device comprising:
the light-diffusion member according to claim 2; and
a plurality of daylighting sections transparent to visible light provided on a second face of the first base member.

11. The daylighting device according to claim 9, wherein the daylighting sections are arrayed in a direction that crosses the direction in which the cylindrical lenses are arrayed.

12. The daylighting device according to claim 9, wherein
the height of the lens surface changes with a prescribed period, and
the period of the changing height of the lens surface differs from an array period of the daylighting sections.

13. The daylighting device according to claim 9, wherein the cylindrical lenses each include a light-scattering member therein.

14. The daylighting device according to claim 9, wherein the cylindrical lenses each include a light-scattering structure on a surface thereof.

15. The daylighting device according to claim 10, wherein the daylighting sections are arrayed in a direction that crosses the direction in which the cylindrical lenses are arrayed.

16. The daylighting device according to claim 10, wherein
the height of the lens surface changes with a prescribed period, and
the period of the changing height of the lens surface differs from an array period of the daylighting sections.

17. The daylighting device according to claim 10, wherein the cylindrical lenses each include a light-scattering member therein.

18. The daylighting device according to claim 10, wherein the cylindrical lenses each include a light-scattering structure on a surface thereof.
